(19) United States
(12) Patent Application Publication
(10) Pub. No.: US 2010/0060691 A1
(43) Pub. Date: Mar. 11, 2010

(54) PRINTING METHOD AND PRINTER

(75) Inventors: Kazuyoshi Tanase, Shiojiri-shi (JP); Toru Takahashi, Azumino-shi (JP); Toru Miyamoto, Shiojiri-shi (JP); Hirokazu Kasahara, Okaya-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/556,501

(22) Filed: Sep. 9, 2009

(30) Foreign Application Priority Data
Sep. 10, 2008 (JP) 2008-232492
Aug. 11, 2009 (JP) 2009-186771

(51) Int. Cl. B41J 29/38

(52) U.S. Cl. 347/14

(57) ABSTRACT

[Task] To achieve reduction of the number of correction value tables.

[Means for Resolution] A printing method includes: printing a test pattern, in which a plurality of pixel rows including a plurality of pixels arranged in a predetermined direction are arranged in a direction intersecting the predetermined direction, on a kind of medium; reading the test pattern printed on the kind of medium by using a reading unit; obtaining a density correction value for each pixel row on the basis of the read result of the test pattern, and creating a correction value table in which each pixel row is associated with each correction value; performing correction on each pixel row using the correction value table when the printing is performed on the kind of medium; and performing correction on each pixel row using the correction value table for the kind of medium when the printing is performed on another kind of printing target medium.

### BACKGROUND

1. Technical Field

The present invention relates to a printing method and a printing apparatus.

2. Related Art

For example, when images are formed on a medium (for example, paper) by a printing apparatus such as an ink jet printer, there may be uneven density in a stripe shape. Thus, density correction is performed such that a correcting pattern is formed for each color of ink using the printing apparatus, the correcting pattern is read by a scanner or the like, and correction values are calculated on the basis of color information obtained from the resulting color information (for example, JP-A-2005-205691).

[Patent Document 1] JP-A-2005-205691

### DISCLOSURE OF THE INVENTION

### Problems that the Invention is to Solve

In the past, correction tables are created for each kind of medium. For this reason, there is a problem in that the creation of the correction value table is cumbersome and takes much time. In addition, when the correction value table is created for each kind of medium, there is a problem in that the number of the correction value tables is large.

An object of the invention is to achieve reduction of the number of correction value tables.

### SUMMARY

The main invention for achieving the above-mentioned object is to provided a printing method which includes: printing a test pattern, in which a plurality of pixel rows including a plurality of pixels arranged in a predetermined direction are arranged in a direction intersecting the predetermined direction, on a kind of medium; reading the test pattern printed on the kind of medium by using a reading unit; obtaining a density correction value for each pixel row on the basis of the read result of the test pattern, and creating a correction value table in which each pixel row is associated with each correction value; performing correction on each pixel row using the correction value table when the printing is performed on the kind of medium; and performing correction on each pixel row using the correction value table for the kind of medium when the printing is performed on another kind of printing target medium.

### BRIEF DESCRIPTION OF THE DRAWINGS

Other characteristics of the invention will be apparent with reference to the specification and the accompany drawings.

FIG. 1 is a block diagram illustrating a configuration of a printing system.

FIG. 2 is a perspective view illustrating a transport process and a dot forming process of a printer.

FIG. 3 is a diagram illustrating an arrangement of plural heads on the lower surface of a head unit.

FIG. 4 is a diagram schematically illustrating a head arrangement and a dot formation.

FIG. 5 is a diagram illustrating a process of a printer driver.

FIG. 6A is a diagram illustrating a case where an ideal raster line is formed. FIG. 6B is a diagram illustrating a case where uneven density occurs. FIG. 6C is a diagram illustrating a case where uneven density is suppressed so as not to occur.

FIG. 7 is a diagram illustrating a flow a correction value acquiring process.

FIG. 8 is a diagram illustrating a correcting pattern CP.

FIG. 9 is a graph illustrating calculation density of each raster line in a sub pattern CSP.

FIG. 10A is a diagram illustrating a sequence of calculating a density correction value Hb for correcting an instructed gradation value Sb of a first raster line. FIG. 10B is a diagram illustrating a sequence of calculating a density correction value Hb for correcting the instructed gradation value Sb of the j-th raster line.

FIG. 11 is a diagram illustrating a correction value table.

FIG. 12 is a diagram illustrating an evaluation pattern which is used in a first embodiment.

FIG. 13 is a diagram illustrating ΔE94.

FIG. 14 is a diagram illustrating a measurement result of ΔE94 for each sub pattern in an evaluation pattern.

FIG. 15 is a flowchart illustrating selection sequence of a correction value table.

FIG. 16 is a diagram illustrating plural correction value tables.

FIG. 17 is a diagram illustrating a relationship between a correction amount of a correction value table and a nozzle position (band).

FIG. 18 is a diagram illustrating difference in brightness values of each band of a printing target paper and a base paper.

FIG. 19 is a diagram illustrating a relationship between each sub pattern CSP and a brightness value of each band acquired from a printing target paper.

FIG. 20 is a diagram illustrating a method of obtaining a correction amount of an offset.

FIG. 21 is a diagram illustrating a correction amount of each band in a sub pattern CSP(2).

FIG. 22 is a diagram illustrating a correction value table after being offset.

FIG. 23 is a flowchart illustrating a process of a fourth embodiment.

FIG. 24 is a block diagram illustrating a configuration of a printing system of a fifth embodiment.

FIG. 25 is a diagram specifically illustrating an example of an ink ejecting mechanism.

FIG. 26 is a diagram illustrating a part of an example of a driving signal COM.

FIG. 27 is a diagram illustrating a driving signal COM.

FIG. 28 is a diagram illustrating an example of an evaluation pattern which is used in the fifth embodiment.

FIG. 29 is a diagram illustrating a concept of a color difference formula ΔE94.

FIG. 30 is a conceptual diagram illustrating spatial frequency characteristics VTF.

FIG. 31 is a flowchart illustrating a printing process according to the fifth embodiment.

FIG. 32 is a diagram illustrating selection of a dot size according to the fifth embodiment.

FIG. 33 is a diagram illustrating a case where a voltage amplitude of the entire driving signal COM is changed. FIG. 33A is a diagram illustrating a case where the voltage amplitude of the entire driving signal COM increases. FIG. 33B is a diagram illustrating a case where the voltage amplitude of the entire driving signal COM decreases. FIG. 33C is a modified example of that shown in FIG. 33A.

FIG. 34 is a diagram illustrating selection of a dot size of according to a sixth embodiment.

FIG. 35 is a diagram illustrating an example of an evaluation pattern which is used in a seventh embodiment.

FIG. 36 is a diagram illustrating an example of an evaluation pattern which is used in an eighth embodiment.

### DESCRIPTION OF REFERENCE NUMERALS AND SIGNS

1: PRINTER
20: HEAD UNIT
23: HEAD
23A: FIRST HEAD
23B: SECOND HEAD
23C: THIRD HEAD
30: TRANSPORT UNIT
32A: UPSTREAM ROLLER
32B: DOWNSTREAM ROLLER
34: BELT
40: DETECTOR GROUP
50: CONTROLLER
51: INTERFACE
52: CPU
53: MEMORY
54: UNIT CONTROL CIRCUIT
62: DRIVING UNIT
621: PIEZO ELEMENT
623: FIXING PLATE
624: FLEXIBLE CABLE
64: FLUID CHANNEL UNIT
65: FLUID CHANNEL FORMATION SUBSTRATE
651: PRESSURE CHAMBER
652: INK SUPPLY PORT
653: RESERVOIR
66: NOZZLE PLATE
67: ELASTIC PLATE
673: ISLAND PORTION
70: DRIVING SIGNAL GENERATING CIRCUIT
100: PRINTING SYSTEM
110: COMPUTER
111: INTERFACE
112: CPU
113: MEMORY
120: SCANNER
121: READING CARRIAGE
122: INTERFACE
123: CPU
124: MEMORY
125: SCANNER CONTROLLER

### DESCRIPTION OF EXEMPLARY EMBODIMENTS

At least the following facts will be apparent through the specification and the accompanying drawings.

According to an aspect of the invention, there is provided a printing method which includes: printing a test pattern, in which a plurality of pixel rows including a plurality of pixels arranged in a predetermined direction are arranged in a direction intersecting the predetermined direction, on a kind of medium; reading the test pattern printed on the kind of medium by using a reading unit; obtaining a density correction value for each pixel row on the basis of the read result of the test pattern, and creating a correction value table in which each pixel row is associated with each correction value; performing correction on each pixel row using the correction value table when the printing is performed on the kind of the medium; and performing correction on each pixel row using the correction value table for the kind of medium when the printing is performed on another kind of printing target medium.

According to such a printing method, since the correction value table is not created for all kinds of medium, it is possible to reduce the number of the correction value tables.

In the printing method, it is preferable that the method further include: printing a test pattern, to which the correction value table for the kind of medium is applied, on the printing target medium by changing dot size; and reading the test pattern to which the correction value table is applied by using the reading unit, and selecting a dot size such that density deviation is in a predetermined range and granularity is in an allowable range on the basis of the read result. In addition, when the printing is performed on the printing target medium, the selected dot size may be used.

According to such a printing method, since the density deviation and the granularity are taken into account, the correction value table created by any kind of medium is used in printing on the printing target medium, so that the printing can be properly carried out.

In the printing method, it is preferable that the dot size be changed by changing a voltage amplitude of a driving signal for driving an element which ejects liquid.

According to such a printing method, adjustment of the dot size can be accurately and easily carried out.

In the printing method, when the test pattern, to which the correction value table is applied, is printed on the printing target medium, a plurality of dot sizes may be mixed in each pattern in a predetermined ratio, the respective dot sizes may be changed in each pattern. In addition, a plurality of the dot sizes, of which the density deviation is in the predetermined range and the granularity is in the allowable range, and which are used for forming the pattern, may be selected on the basis of the read result of the test pattern to which the correction value table is applied.

According to such a printing method, the printing can be carried out by taking into account the uneven density and the graininess using plural dot sizes.

In the printing method, it is preferable that a difference between an average value obtained by reading the pixel rows of the test pattern and a value obtained by reading each pixel row be obtained for each pixel row, and the density deviation be calculated on the basis of an average of the differences obtained for the respective pixel rows.

According to such a printing method, the range of the density deviation can be accurately specified.

In the printing method, it is preferable that the granularity be calculated on the basis of calculation of a Wiener spectrum calculated on the basis of Fourier conversion implemented on the read result of the test pattern and spatial frequency characteristics which are visual characteristics.

According to such a printing method, the range of the granularity can be accurately specified.

In addition, it is preferable that the printing method further include: creating the correction value table for each of a plurality of mediums, resolution, and dot size; printing a test pattern, to which each of the plurality of the correction value tables is applied, on the printing target medium; and determining an optimal pattern among the test patterns which are printed on the printing target medium. Here, when the printing is performed on the printing target medium, it is preferable that the correction be carried out using the correction value table corresponding to the optimal pattern.

According to such a printing method, the correction can be properly carried out to be more suitable for the printing target medium.

In the printing method, it is preferable that the method further include: reading the test pattern, which is printed on the printing target medium, by the reading unit; and calculating, for each pixel row, a difference between an average value obtained by reading pixel rows of the test pattern and a value obtained by reading each pixel row. Here, it is preferable that the optimal pattern be determined on the basis of an average value of the differences obtained for the respective pixel rows.

According to such a printing method, the correction value table can be accurately selected so as to be suitable for reducing uneven density of the pixel row.

In the printing method, it is preferable that the method further include: printing the test pattern without carrying out correction on the printing target medium; reading the test pattern printed on the printing target medium by the reading unit; and calculating an offset value for each predetermined region, which is configured by a plurality of the pixel rows, on the basis of the read result. Here, when the printing is performed on the printing target medium, it is preferable that the correction value table for the kind of medium be adjusted by the offset value for each predetermined region so as to perform the correction.

According to such a printing method, the effect can be obtained such that the correction is carried out which is close to the correction value table created using the printing target medium.

In the printing method, it is preferable that the method further include: creating the correction value table for each of a plurality of mediums; printing the test pattern without carrying out correction on the printing target medium; reading the test pattern printed on the printing target medium by the reading unit; calculating an offset value of each predetermined region, which is configured by a plurality of the pixel rows, on the basis of the read result; adjusting each correction value table by the offset value so as to print a test pattern on the printing target medium; and determining an optimal pattern among the test patterns which are printed on the printing target medium. Here, when the printing is performed on the printing target medium, it is preferable that the correction value table corresponding to the optimal pattern be adjusted by the offset value so as to perform the correction.

According to such a printing method, it is possible to further reduce uneven density.

According to another aspect of the invention, there is provided a printing apparatus which includes: a printing unit which performs printing on a medium by changing dot size; a reading unit which reads the printed medium; and a control unit which prompts a test pattern, in which a plurality of pixel rows including a plurality of pixels arranged in a predetermined direction are arranged in a direction intersecting the predetermined direction, to be printed on a kind of medium; obtains a density correction value for each pixel row on the basis of the read result of the test pattern and creates a correction value table in which each pixel row is associated with each correction value; prompts a test pattern, to which the correction value table for the kind of medium is applied, to be printed on another kind of printing target medium different from the kind of the printing target medium by changing dot size; prompts a dot size, in which a density deviation is in a predetermined range and granularity is in an allowable range, to be selected on the basis of the read result of the reading unit reading which is obtained the test pattern printed on the printing target medium; and prompts each pixel row to be corrected by the correction value table using the selected dot size when the printing is performed on the printing target medium.

According to such a printing apparatus, the correction value table created by any kind of the medium is used in printing on the printing target medium, so that the printing can be properly carried out.

===Regarding the Printing System===

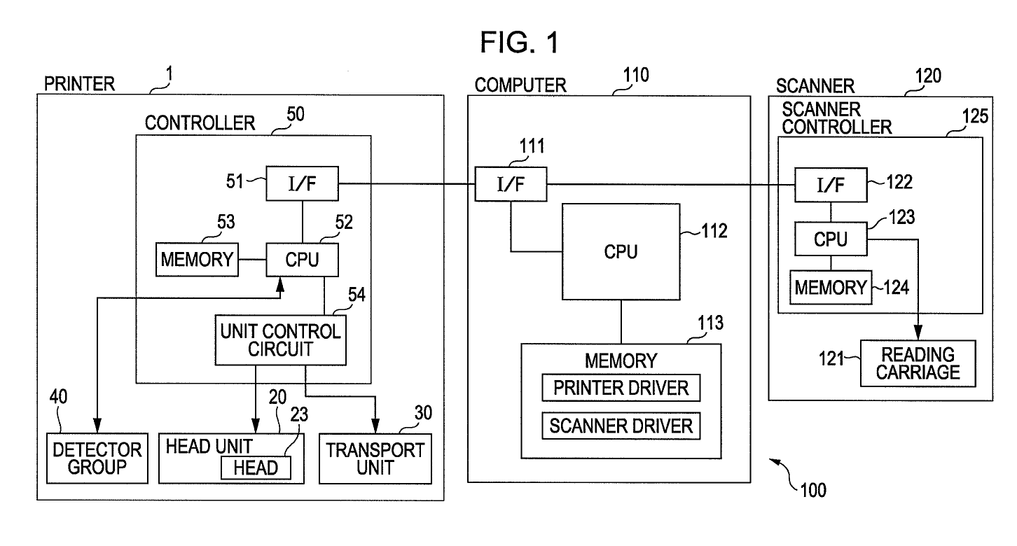

In order to describe uneven density of images and a method of suppressing uneven density, first a printing system 100 for forming an image on a medium will be described with reference to FIG. 1. FIG. 1 is a block diagram illustrating a configuration of the printing system 100.

As shown in FIG. 1, the printing system 100 according to this embodiment is a system which including a printer 1, a computer 110, and a scanner 120.

The printer 1 is a liquid ejecting apparatus for forming (printing) an image on the medium by ejecting ink as liquid onto the medium, and a color ink jet printer is employed in this embodiment. The printer 1 can print an image on a plurality of kinds of mediums such as paper, cloth, and film sheets. Further, the configuration of the printer 1 will be described later.

The computer 110 includes an interface 111, a CPU 112, and a memory 113. The interface 111 carries out the transmission and reception between the printer 1 and the scanner 120. The CPU 112 carries out the entire control of the computer 110, and performs various programs which are installed on the computer 110. The memory 113 stores various programs or a variety of data. Among the programs installed on the computer 110, there are a printer driver for converting image data output from applications and a scanner driver for controlling the scanner 120. Then, the computer 110 outputs printing data generated by the printer driver to the printer 1.

The scanner 120 includes a scanner controller 125 and a reading carriage 121. The scanner controller 125 includes an interface 122, a CPU 123, and a memory 124. The interface 122 communicates with the computer 110. The CPU 123 carries out the entire control of the scanner 120. For example, the CPU 123 controls the reading carriage 121. The memory 124 stores computer programs. The reading carriage 121 includes three sensors (not shown) (CCD etc.) corresponding to R (red), G (green), and B (blue), for example.

With such a configuration as described above, the scanner 120 irradiates light onto a document which is placed on a platen (not shown), detects the reflective light by each sensor of the reading carriage 121, reads an image on the document, and acquires color information of the image. Then, the scanner 120 transmits the data (read data) indicating the color information of the image to the scanner driver of the computer 110 via the interface 122.

Further, a “printing apparatus” mean the printer 1 in a narrow sense, and also means the printer 1, the computer 110, and the scanner 120 in a broad sense.

<Configuration of Printer 1>

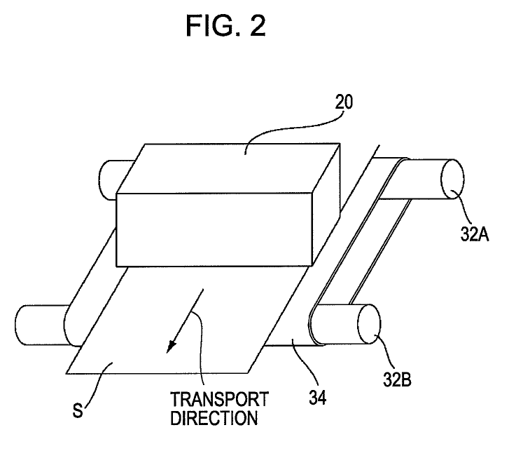

Next, the configuration of the printer 1 will be described with reference to FIGS. 1 and 2. FIG. 2 is a perspective view illustrating a transport process and a dot forming process of the printer 1.

As shown in FIG. 1, the printer 1 includes a head unit 20, a transport unit 30, a detector group 40, and a controller 50. When the printer 1 receives the printing data from the computer 110, the controller 50 controls the respective units (the head unit 20, and the transport unit 30) on the basis of the printing data and prints the image on the printing medium. The status in the printer 1 is monitored by the detector group 40, and the detector group 40 outputs signals according to the detection result to the controller 50.

The head unit 20 ejects ink onto the paper S. The head unit 20 ejects ink onto the transporting paper S so as to form dots on the paper S, and thus an image is printed on the paper S. The printer 1 according to this embodiment is a line printer, and the head unit 20 can form dots by a line width at a time.

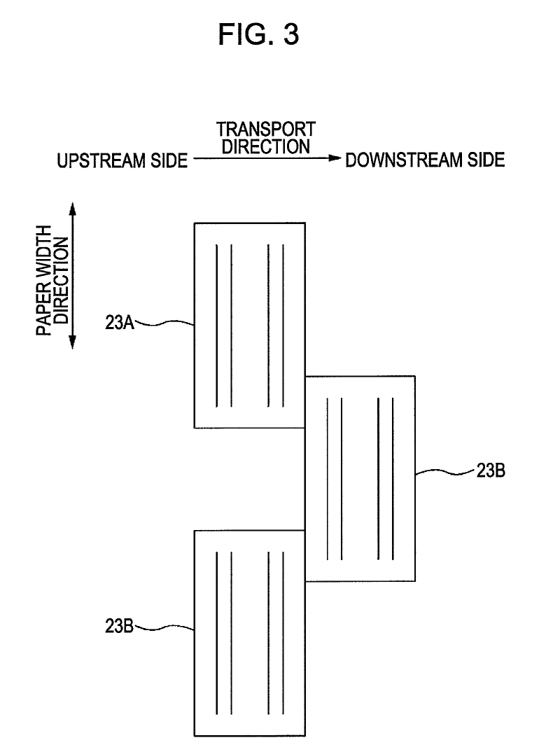

FIG. 3 is a diagram illustrating an arrangement of plural heads on the lower surface of a head unit 20. As shown in the drawing, plural heads 23 are arranged in a zigzag shape along a paper width direction. In this embodiment, in order to simplify explanation, it is assumed that three heads (a first head 23A, a second head 23B, and a third head 23C) are provided. In each head, there are formed with a black ink nozzle row, a cyan ink nozzle row, a magenta ink nozzle row, and a yellow ink nozzle row, and all of which are not shown. Each nozzle row is provided with plural nozzles for ejecting ink. The plural nozzles of each nozzle row are arranged at a constant nozzle pitch along the paper width direction.

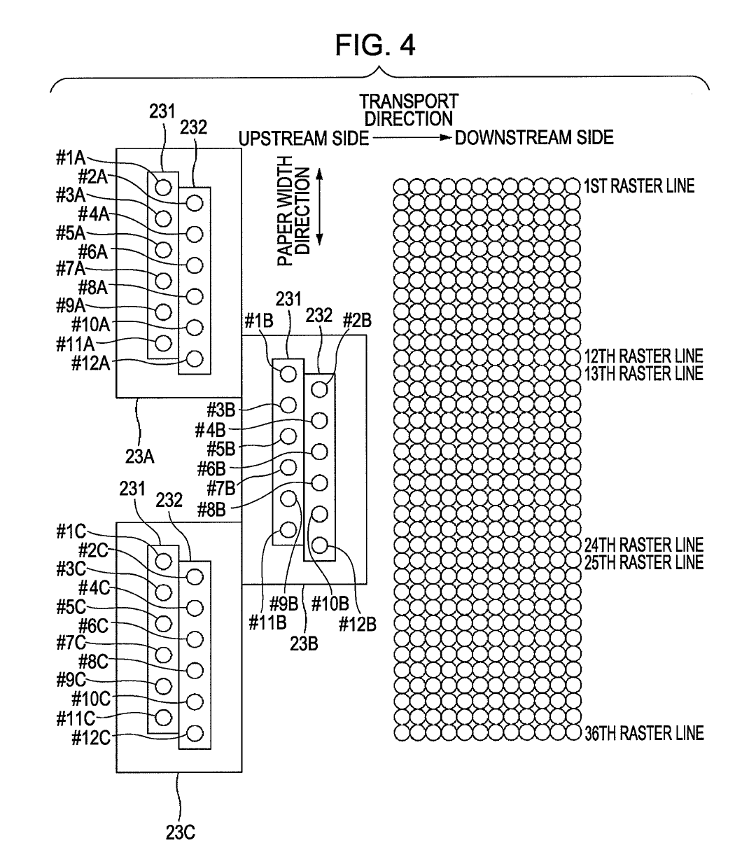

FIG. 4 is a diagram schematically illustrating the head arrangement and the dot formation. In order to simplify explanation, only one nozzle row (for example, the yellow ink nozzle row) of each head is illustrated. In order to further simplify explanation, the number of the nozzles provided at the nozzle row of each head is assumed to be 12.

With each of these nozzles, a row of dots is formed which are arranged in a direction in which the head and the paper relatively move. The dot row is called a “raster line”. In a case of the line printer as in this embodiment, the “raster line” means a row of dots which are arranged in the transport direction of the paper. Further, in a case of a serial printer in which the printing is performed by the head mounted on the carriage, the “raster line” means a row of dots which are arranged in the moving direction of the carriage. In the following, as shown in the drawing, the raster line on an n-th position is called an “n-th raster line”.

As shown in the drawing, the nozzle row of each head is provided with a first nozzle group 231 and a second nozzle group 232. Each nozzle group is configured with six nozzles which are arranged at 1/180 inch intervals in the paper width direction. The first nozzle group 411 and the second nozzle group 412 are configured so as to be shifted by 1/360 inch in the paper width direction. With this configuration, the nozzle row of each head is a nozzle row which is configured with 12 nozzles arranged at 1/360 inch intervals in the paper width direction. The nozzle rows of each head are denoted by the number in order from the top in the drawing.

Then, the ink droplets are intermittently ejected from each nozzle onto the transporting paper S, so that 36 raster lines are formed on the paper S. For example, the nozzle #1A of the first head 23A forms a 1st raster line on the paper S, the nozzle #1B of the second head 23B forms a 13th raster line on the paper S. In addition, the nozzle #1C of the third head 23C forms a 25th raster line on the paper S. Each raster line is formed along the transport direction. Further, in the above-mentioned description, a region (the 1st raster line to the 12th raster line) printed by the first head 23A is also referred to as Band 1, a region (the 13th raster line to the 24th raster line) printed by the second head 23B is also referred to as Band 2, and a region (the 25th raster line to the 36th raster line) printed by the third head 23C is also referred to as Band 3.

The transport unit 30 transports the medium (for example, the paper S etc.) in the transport direction. The transport unit 30 includes an upstream roller 32A, a downstream roller 32B, and a belt 34. When a transport motor (not shown) rotates, the upstream roller 32A and the downstream roller 32B rotate, and thus the belt 34 rotates. The fed paper S is transported up to a printable region (a region facing the head) by the belt 34. The belt 34 transports the paper S, so that the paper S moves in the transport direction with respect to the head unit 20. The paper S passed through the printable region is discharged outside by the belt 34. Further, the transporting paper S is electrostatically absorbed or is vacuum-absorbed to the belt 34.

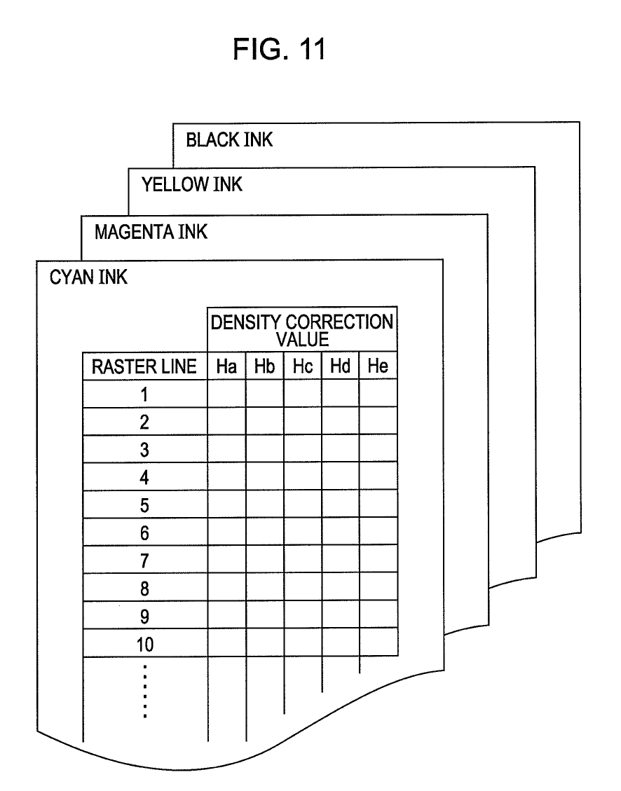

The controller 50 controls the respective units of the printer 1 via a unit control circuit 54 by the CPU 52. In addition, the printer 1 includes a memory 53 which is provided with a storage element, and a density correction value H is stored in the memory 53 (see FIG. 11). Further, the density correction value H will be described later.

<Regarding the Printing Process>

In this kind of the printer 1, when the printing data is received from the computer 110, the controller 50 first prompts the transport unit 30 to rotate a paper feeding roller (not shown), and sends the paper S to be printed onto the belt 34. The paper S is transported on the belt 34 at a predetermined speed without stopping, and passes through under the head unit 20. As the paper S passes through under the head unit 20, ink is intermittently ejected from the respective nozzles of the first head 23A, the second head 23B, and the third head 23C. That is, the dot forming process and the transport process of the paper S are carried out at the same time. As a result, dot rows which are configured with plural dots along the transport direction and the paper width direction are formed on the paper S, so that the image is printed. Finally, the controller 50 discharges the paper S on which printing of the image is complete.

<Outline of Processes carried out by Printer Driver>

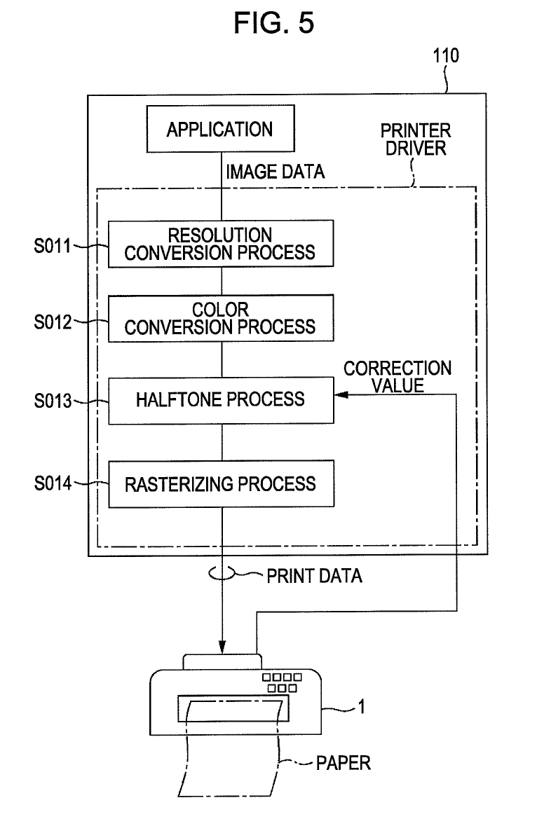

As described above, the above-mentioned printing process is started by transmitting the printing data from the computer 110 connected to the printer 1. The printing data is generated by a process of the printer driver. In the following, the process of the printer driver will be described with reference to FIG. 5. FIG. 5 is a diagram illustrating the process of the printer driver.

As shown in FIG. 5, the printing data is generated by performing a resolution conversion process (S011), a color conversion process (S012), a halftone process (S013), and a rasterizing process (S014) by the printer driver.

First, in the resolution conversion process, the resolution of RGB image data obtained by performing the application program is converted into the printing resolution corresponding to the specified image quality. Next, in the color conversion process, the RGB image data of which the resolution is converted is converted into CMYK image data. Here, the CMYK image data means the image data of each color of cyan (C), magenta (M), yellow (Y), and black (K). Then, a plurality of pieces of the pixel data constituting the CMYK image data is expressed by the gradation values in 256 steps. The gradation value is determined on the basis of the RGB image data, and hereinafter referred to as an instructed gradation value.

Next, in the halftone process, a gradation value in multiple steps indicating the pixel data constituting the image data is converted into a dot gradation value in small steps which can be expressed by the printer 1. That is, the gradation value in 256 steps indicating the pixel data is converted into a dot gradation in 4 steps. Specifically, the gradation value is converted into 4 steps with No Dot corresponding to the dot gradation value “00”, forming of Small Dot corresponding to the dot gradation value “01”, forming of Medium Dot corresponding to the dot gradation value “10”, and forming of Large Dot corresponding to the dot gradation value “11”. Thereafter, a dot formation rate of each dot size is determined, and then the printer 1 uses the dither method, γ correction, and an error diffusion method so as to form the dots by dispersing, so that the pixel data is created.

Next, in the rasterizing process, each dot data of the image data which is obtained by the halftone process is converted in order of data to be transmitted to the printer

1. Then, the rasterized data is transmitted as a part of the printing data.

===Suppression of Uneven Density===

Next, the uneven density occurring in the image which is printed using the above-mentioned printer 1 and a method of suppressing uneven density will be described.

In order to explanation in the following, a “pixel region” and a “row region” are set. The pixel region is a rectangular region which is virtually identified on the paper S, and the size and the shape thereof are identified according to the printing resolution. Then, one pixel region corresponds to one “pixel” included in the image data. In addition, the “row region” is a region on the paper S, which includes plural pixel regions arranged in the transport direction. One row region corresponds to a “pixel row” in which pixels are arranged in a direction to the transport direction in the data.

<Regarding Uneven Density>

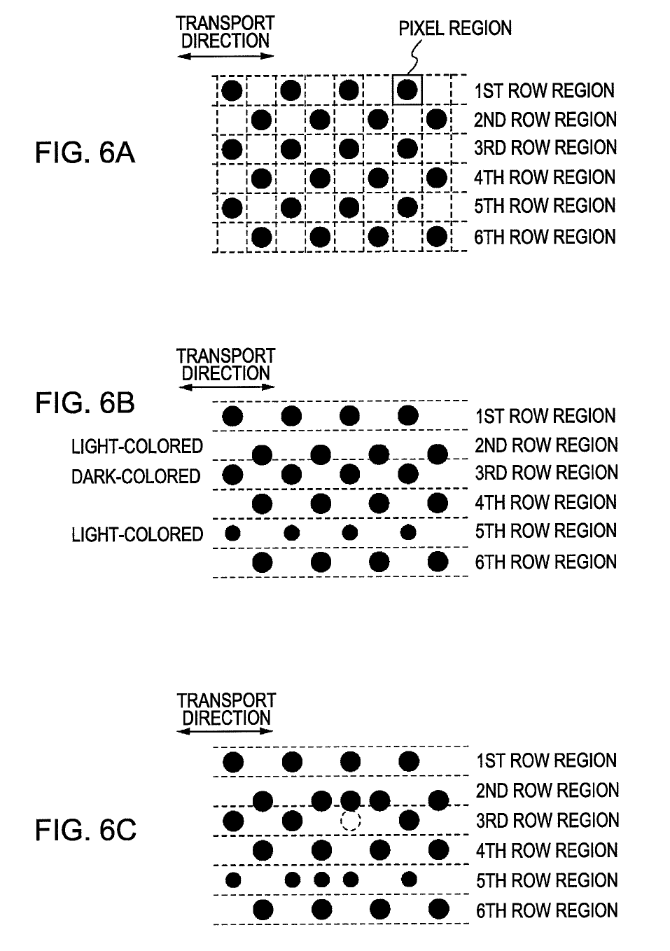

First, the uneven density will be described with reference to the drawings. FIG. 6A is a diagram illustrating a case where ideal dots are formed. That the ideal dot is formed means that an ink droplet is landed at the center position of the pixel region, the ink droplet widens on the paper S, and the dot is formed in the pixel region. When the respective dots are accurately formed in the respective pixel region, the raster line (the dot row in which the dots are arranged in the transport direction) is accurately formed in the row region.

FIG. 6B is a diagram illustrating a case where uneven density occurs. The raster line formed in the second row region is formed close to the third row region due to the deviation in a travel direction of the ink droplet which is ejected from the nozzle. As a result, the second row region is light-colored, and the third row region is dark-colored. In addition, the ink amount of the ink droplet ejected in the fifth row region is smaller and the dots formed in the fifth row region is smaller. As a result, the fifth row region is light-colored.

Taking a broad view of the printing image configured with the raster lines in which a difference in contrasting density appears, streaky uneven density is identified along the transport direction. The uneven density acts as a cause in the reduction of the image quality of the printing image.

<Regarding a Method of Suppressing the Uneven Density>

As a scheme for suppressing uneven density, the method takes into account that the gradation value (the instructed gradation value) of the pixel data is corrected. That is, the row region which is likely to be identified as dark (light) may be corrected such that the gradation value of the pixel data corresponding to a unit region constituting the row region is corrected so as to be formed to be light (dark). For this reason, the density correction value H is calculated for correcting the gradation value of the pixel data for each raster line. The density correction value H is a value reflecting the uneven density characteristics of the printer 1.

When the density correction value H of each raster line is calculated, the printer driver carries out a process of correcting the gradation value of the pixel data for each raster line on the basis of the density correction value H when the halftone process is performed. When each raster line is formed with the gradation value which is corrected by the correction process, as shown in FIG. 6C, the uneven density in the printing image is suppressed since the density of the raster line is corrected. FIG. 6C is a diagram illustrating a case where uneven density is suppressed so as not to occur.

For example, in the FIG. 6C, the gradation values of the pixel data of the pixels which correspond to the respective row regions are corrected such that the dot formation rates of the second and fifth row regions which are identified as light are increased and the dot formation rate of the third row region which are identified as dark are decreased. In this way, the dot formation rate of the raster line of each row region is changed, and the density of the image pieces of the row region is corrected, so that the entire uneven density of each printing image is suppressed.

<Regarding the Calculation of the Density Correction Value H>

Next, a process (hereinafter, referred to also as a correction value acquiring process) of calculating the density correction value H of each raster line will be schematically described. The correction value acquiring process is carried out under a correction value calculating system 200, for example, on a testing line of a factory manufacturing the printer 1. The correction value calculating system is a system for calculating the density correction value H according to the uneven density characteristics of the printer 1, and is configured the same as that of the above-mentioned printing system 100. That is, the correction value calculating system includes the printer 1, the computer 110, and the scanner 120 (for convenience of explanation, the same reference numerals as those of the printing system 100 are designated).

The printer 1 is a target machine in the correction value acquiring process, and the density correction value H for the printer 1 are calculated in the above-mentioned correction value acquiring process in order to print the image without uneven density using the printer 1. Further, the description of the configurations of the printer 1 is already given so it will be omitted. In the computer 110 provided on the testing line, there is installed a correction value calculating program which is used by the computer 110 to perform the correction value acquiring process.

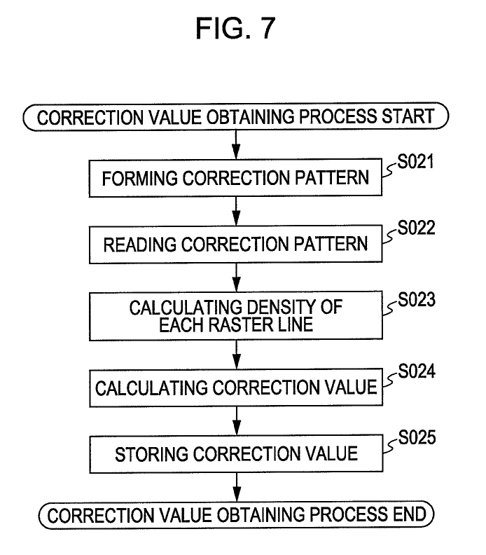

In the following, the schematic procedure of the correction value acquiring process will be described with reference to FIG. 7. FIG. 7 is a diagram illustrating a flow the correction value acquiring process. Further, as in this embodiment, when the printer 1 capable of multi-color printing is employed as a target, the correction value acquiring process for each color of ink is performed in the same procedure. In the following description, the correction value acquiring process for one ink color (for example, yellow) will be described.

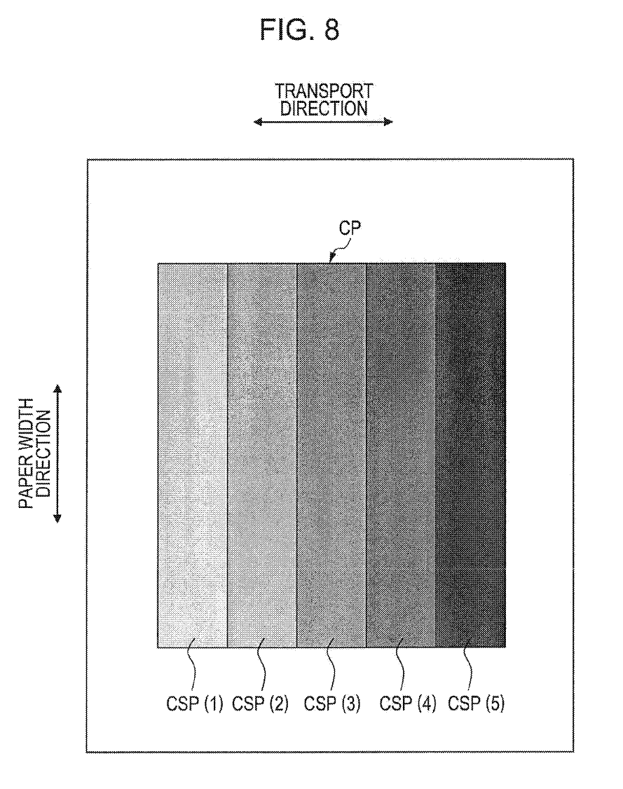

First, the computer 110 transmits the printing data to the printer 1, and the printer 1 forms a correcting pattern CP on the paper S in the same procedure as the above-mentioned printing operation (S021). As shown in FIG. 8, the correcting pattern CP is formed by sub patterns CSP in a five kinds of density. Further, the FIG. 8 is a diagram illustrating the correcting pattern CP.

Each sub pattern CSP is a stripe-like pattern, and is configured with plural raster lines along the transport direction which are arranged in the paper width direction. In addition, each sub pattern CSP is generated from the image data with a predetermined gradation value (the instructed gradation value), and as shown in FIG. 8, from the left sub pattern CSP, the density thereof is identified as dark. Specifically, the sub patterns of 15%, 30%, 45%, 60%, and 85% are arranged from the left. In the following, the instructed gradation value of the sub pattern CSP with the density of 15% is denoted as Sa, the instructed gradation value of the sub pattern CSP with the density of 30% is denoted as Sb, the instructed gradation value of the sub pattern CSP with the density of 45% is denoted as Sc, the instructed gradation value of the sub pattern CSP with the density of 60 is denoted as Sd, and the instructed gradation value of the sub pattern CSP with the density of 85% is denoted as Se. For example, the sub pattern CSP formed by the instructed gradation value Sa is denoted as CSP(1) as shown in FIG. 8. Similarly, the sub patterns CSP formed by the instructed gradation values Sb, Sc, Sd, and Se are denoted as CSP(2), CSP(3), CSP(4), and CSP(5), respectively.

Next, a tester sets the paper S, on which the correcting pattern CP is formed, on the scanner 120. Then, the computer 110 prompts the scanner 120 to read the correcting pattern CP so as to acquire the result (S022). The scanner 120 includes three sensors corresponding to R (red), G (green), and B (blue) as described above, irradiates light onto the correcting pattern CP, and detects the reflective light by using each sensor. Further, the computer 110 performs adjustment on the image data obtained by reading the correcting pattern such that the number of the pixel rows in which the pixels arranged in a direction corresponding to the transport direction is equal to the number of the raster lines (the number of the row regions) which constitutes the correcting pattern. That is, the pixel rows read by the scanner 120 are associated with the row regions in a one-to-one manner. Then, an average value of the read gradation values represented by the respective pixels in the pixel row corresponding to the row region is set as the read gradation value of the row region.

Next, the computer 110 calculates the density of each raster line (in other words, the row region) in each sub pattern CSP on the basis of the read gradation value obtained by the scanner 120 (S023). In the following, the density calculated on the basis of the read gradation value is referred to as calculation density.

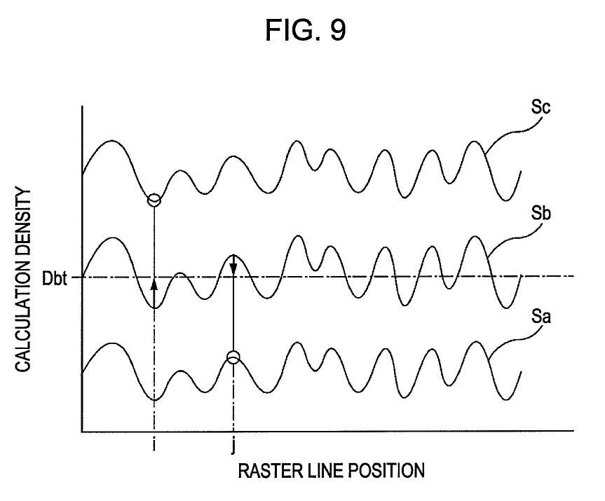

FIG. 9 is a graph illustrating the calculation density of each raster line in the sub pattern CSP of the instructed gradation values Sa, Sb, and Sc. The horizontal axis in FIG. 9 shows a position of the raster line, and the vertical axis shows a size of the calculation density. As shown in FIG. 9, in each sub pattern CSP, the contrasting density occurs in each raster line even though each sub pattern CSP is formed by the same instructed gradation value. The difference in the contrasting density of the raster line acts as a cause of uneven density in the printing image.

Next, the computer 110 calculates the density correction value H of each raster line (S024). Further, the density correction value H is calculated for each instructed gradation value. In the following, the density correction values H calculated for the instructed gradation Sa, Sb, Sc, Sd, and Se is referred to as Ha, Hb, Hc, Hd, and He. In order to explain a procedure of calculating the density correction value H, the procedure of calculating the density correction value Hb for correcting the instructed gradation value Sb such that the calculation density of each raster line in the sub pattern CSP(2) of the instructed gradation value Sb is constant will be described as an example. In the procedure, for example, the average value Dbt of the calculation density of all the raster lines in the sub pattern CSP(2) of the instructed gradation value Sb is set as a target density of the instructed gradation value Sb. In FIG. 9, the 1st raster line of which the calculation density is identified as light compared with the target density Dbt may be corrected such that the instructed gradation value Sb is adjusted to be darker. On the other hand, the j-th raster line of which the calculation density is identified as dark compared with the target density Dbt may be corrected such that the instructed gradation value Sb is adjusted so as to be lighter.

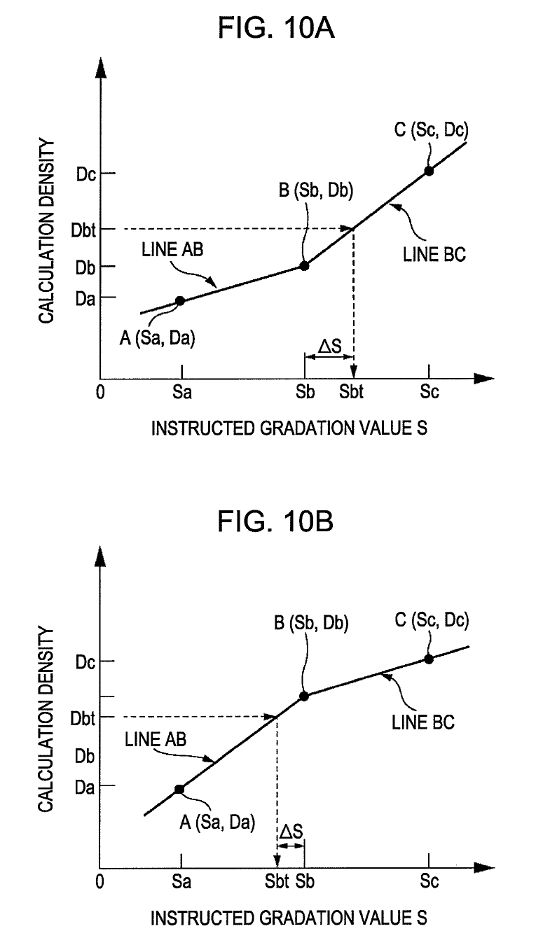

FIG. 10A is a diagram illustrating a sequence of calculating the density correction value Hb for correcting an instructed gradation value Sb of a first raster line. In addition, FIG. 10B is a diagram illustrating a sequence of calculating the density correction value Hb for correcting the instructed gradation value Sb of the j-th raster line. The horizontal axis in FIGS. 10A and 10B shows the size of the instructed gradation value, and the vertical axis shows the calculation density.

The density correction value Hb for the instructed gradation value Sb of the i-th raster line is calculated on the basis of the calculation density Db of the i-th raster line in the sub pattern CSP(2) of the instructed gradation value Sc and the calculation density Dc of the i-th raster line in the sub pattern CSP(3) of the instructed gradation value Sc as shown in FIG. 10A. More specifically, in the sub pattern CSP(2) of the instructed gradation value Sb, the calculation density Db of the i-th raster line is smaller than the target density Dbt. In other words, the density of the i-th raster line is identified as light compared with the average density. On the contrary, when the i-th raster line is required to be formed such that the calculation density Db of the i-th raster line is equal to the target density Dbt, the gradation value of the pixel data corresponding to the i-th raster line, that is, the instructed gradation value Sb may be corrected to be a target instructed gradation value Sbt calculated by the following Equation (1), using straight-line approximation from correspondence (Sb, Db) and (Sc, Dc) between the instructed gradation value in the i-th raster line and the calculation density as shown in FIG. 10A.

Sbt=Sb+(Sc−Sb)×{(Dbt−Db)/(Dc−Db)} (1)

Then, the density correction value H for correcting the instructed gradation value Sb of the i-th raster line is obtained from the instructed gradation value Sb and the target instructed gradation value Sbt by the following Equation (2).

Hb=ΔS/Sb=(Sbt−Sb)/Sb (2)

On the other hand, the density correction value Hb for the instructed gradation value Sb of the j-th raster line is calculated on the basis of the calculation density Da of the j-th raster line in the sub pattern CSP(1) of the instructed gradation value Sa and the calculation density Db of the j-th raster line in the sub pattern CSP(2) of the instructed gradation value Sb as shown in FIG. 10B. Specifically, in the sub pattern CSP(2) of the instructed gradation value Sb, the calculation density Db of the j-th raster line is larger than the target density Dbt. On the contrary, when the j-th raster line is required to be formed such that the calculation density Db of the j-th raster line is equal to the target density Dbt, the instructed gradation value Sb corresponding to the j-th raster line, that is, the instructed gradation value Sb may be corrected to be a target instructed gradation value Sbt calculated by the following Equation (3), using straight-line approximation from correspondence (Sa, Da) and (Sb, Db) between the instructed gradation value in the j-th raster line and the calculation density as shown in FIG. 10B.

Sbt=Sb+(Sb−Sa)×{(Dbt−Db)/(Db−Da)} (3)

Then, the density correction value Hb for correcting the instructed gradation value Sb of the j-th raster line is obtained by the following Equation (2).

As described above, the computer 110 calculates the density correction value Hb of each raster line for the instructed gradation value Sb. Similarly, the density correction values Ha, Hc, Hd, and He in each raster line are calculated for the instructed gradation values Sa, Sc, Sd, and Se. In addition, also regarding other ink colors, the density correction values Ha to He in each raster line are calculated for the respective instructed gradation values Sa to Se.

Thereafter, the computer 110 transmits the data of the density correction value H to the printer 1 so as to be stored in the memory 53 of the printer 1 (S025). As a result, in the memory 53 of the printer 1, a correction value table is created which is obtained by collecting the density correction values Ha to He in each raster line for the five instructed gradation values Sa to Se as shown in FIG. 11. FIG. 11 is a diagram illustrating the correction value table which is stored in the memory 53.

In addition, as shown in FIG. 11, the correction value table is created for each ink color. As a result, the correction value tables for four CMYK colors are formed. When the image is printed using the printer 1, the correction value table is referenced by the printer driver in order to correct the gradation values of the respective raster lines constituting the image data of the image.

When the correction value acquiring process is complete, the printer 1 is packaged and shipped after being subjected to other testing steps. Then, when an image is printed by a purchaser (user) of the printer 1, the image with the density corrected by the density correction value H is printed.

For example, the printer driver of the computer 110 of the user corrects the gradation value (hereinafter, the gradation value before correction is referred to as Sin) of each piece of the pixel data on the basis of the density correction value H of the raster line corresponding to the pixel data (hereinafter, the corrected gradation value is referred to as Sout).

Specifically, when the gradation value Sin of a raster line is equal to any one of the instructed gradation values Sa, Sb, Sc, Sd, and Se, the density correction value H which is stored in the memory of the computer 110 can be used as it is. For example, when the gradation value Sin of the pixel data is Sb, the gradation value Sout after correction is obtained by the following Equation.

Sout=Sb×(1+Hb)

On the other hand, when the gradation value of the pixel data is different from the instructed gradation values Sa, Sb, Sc, Sd, and Se, the correction value is calculated on the basis of interpolation using the density correction value of the instructed gradation value in the vicinity thereof. For example, when the instructed gradation value Sin is between the instructed gradation value Sb and the instructed gradation value Sc, the gradation value Sout after correction of the instructed gradation value Sin is obtained by the following Equation. Here, H′ is the correction value obtained by a linear interpolation method using the density correction value Hb of the instructed gradation value Sb and the density correction value Hc of the instructed gradation value Sc.

Sout=Sin×(1+H′)

Therefore, the density correcting process is carried out on each raster line.

### First Embodiment

The correction value acquiring process as described above is performed plural times while the kind of printing medium (for example, the paper S) is changed. This is because when the kind of the paper S is different, the degree of uneven density of the image may be different. Therefore, it is considered that there is a need to create the correction value table which is properly changed for each kind of the paper S. However, it is cumbersome that the correction value tables are created for all kinds of the paper S and it takes much time. In addition, the capacity of the memory 53 of the printer 1 increases for storing the correction value tables.

In this embodiment, the correction value table created by the paper of which the kind is different from that of the printing target paper is also applied when the printing target paper is used in printing. First, there will be described an evaluation pattern and an evaluation index which are used for evaluating the application of the correction value table in the first embodiment.

<Regarding the Evaluation Pattern>

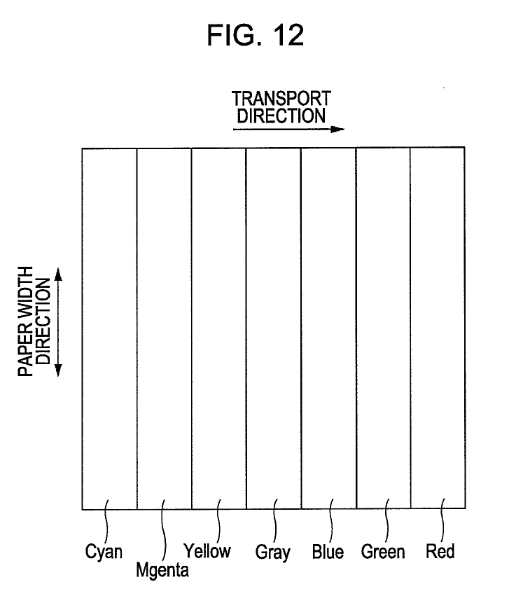

FIG. 12 is a diagram illustrating an example of the evaluation pattern which is used in a first embodiment.

The evaluation pattern is printed on the medium by the printer 1, and formed by plural stripe-like sub patterns similar to the correcting pattern CP.

Each sub pattern is configured such that the plural raster lines along the transport direction are arranged in the paper width direction. In addition, each sub pattern is generated from the image data with a predetermined gradation value. As shown in the drawing, the sub patterns are formed in order of cyan, magenta, yellow, gray, blue, green, and red from the left.

<Regarding the Evaluation Index>

The computer 110 prompts the scanner 120 or the like to read the evaluation pattern described above, and carries out the evaluation of uneven density in each sub pattern.

In this embodiment, as the evaluation index of uneven density, the color difference formula ΔE94 is used. ΔE94 is expressed as in the follow Equation.

ΔE94=√{(ΔH*/Sh)2+(ΔL*/SL)2+(ΔC*/Sc)2}

Further, L*, C*, and H* are intensity, saturation, and hue of an L*a*b* colorimetric system. Here, SL=1, Sc=1+0.045C*, and Sh=1+0.015C*.

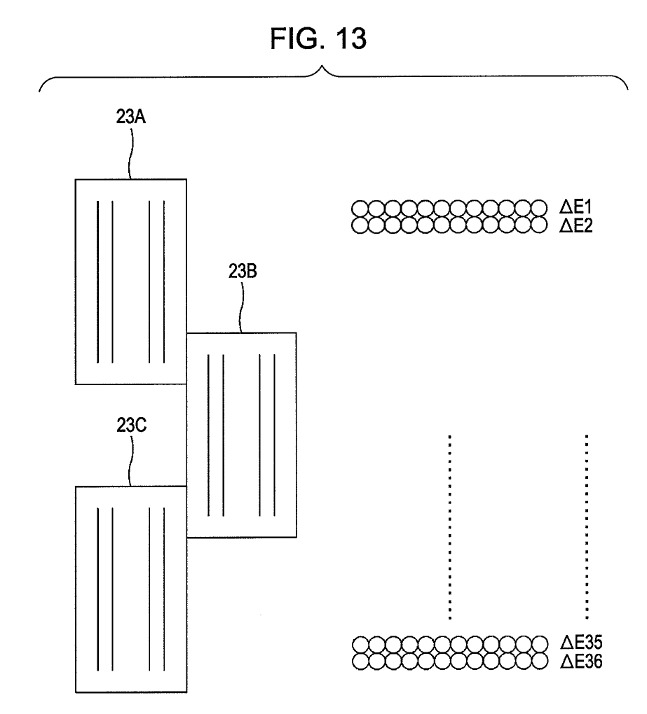

FIG. 13 is a diagram illustrating a concept of the colorimetric formula ΔE94.

When the printing is carried out on the paper S using the nozzles of each head, the raster lines corresponding to the nozzles are formed in the row region of the paper S as described above. The scanner 120 reads the raster lines, so that the RGB value indicating the density of the pixel row corresponding to each raster line is obtained for each pixel row. In this embodiment, the RGB value is converted into a component (hereinafter, referred to as the Lab values) of the L*a*b* colorimetric system. When the average of all the Lab values of the raster lines is denoted as (L*H, a*H, b*H), and the Lab value of the n-th raster line is denoted as (L*n, a*n, b*n), the color difference between the average of the Lab values and the Lab value of the n-th raster line is expressed by a distance between two points in the L*a*b* space. For example, when the Lab value of the 1st raster line is denoted as (L*1, a*1, b*1), the color difference ΔE1 of the average value (L*H, a*H, b*H) is obtained by the following equation.

ΔE1=√{(L*H−L*1)2+(a*H−a*1)2+(b*H−b*1)2}

Similarly, the color difference ΔEn between the average value (L*H, a*H, b*H) and the Lab value of the n-th raster line is obtained. A value obtained by taking an average of these color difference (ΔE1 to ΔE36 in this embodiment) corresponds to ΔE94.

Therefore, as can be seen from the above-mentioned relationship, when uneven density increases (the deviation in the Lab values of the respective raster lines), the value of ΔE94 increases. On the contrary, when uneven density decreases (the deviation in the Lab values of the respective raster lines), the value of ΔE94 decreases.

Further, the evaluation index is not limited to the above-mentioned description. For example, it may be configured such that the absolute value (target value) rather than the average value of the respective raster lines is set, and the color difference between the absolute value and each raster line is obtained.

<Regarding the Evaluation Result>

In the first embodiment, first, the correction value table is created using any kind of the paper S, and in a case where the correction is performed or not performed by the correction value table, the above-mentioned evaluation pattern is printed on another kind of printing target paper. Then, ΔE94 evaluation is carried out for each case.

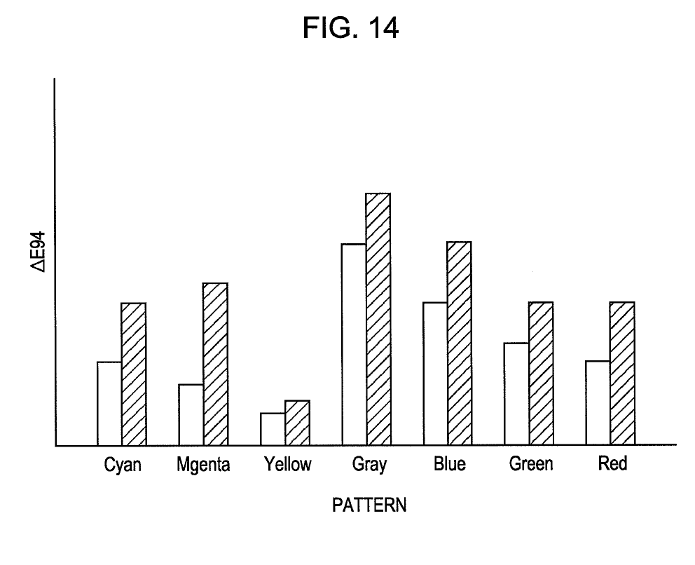

FIG. 14 is a diagram illustrating a measurement result of ΔE94 for each sub pattern in an evaluation pattern.

The horizontal axis in FIG. 14 shows the sub pattern of each color. In addition, in a graph of each sub pattern, the vertical axis in FIG. 14 shows the size of ΔE94. In addition, portions marked with diagonal lines (right side) show the case where the correction is not performed, and portions with a white color (left side) show the case where the correction is performed by the correction value table.

As described above, when uneven density of the respective raster lines increases, the value of ΔE94 increases. When uneven density decreases, the value of ΔE94 decreases. For example, from the drawing, it can be seen that uneven density increases in the gray sub pattern, and uneven density decreases in the yellow sub pattern.

In addition, in each sub pattern, the value of ΔE94 in the case where the correction is performed is smaller than that in the case where the correction is not performed. That is, even though the correction value table is created using a different kind of paper from that of the printing target paper, the correction is carried out using the correction value table, so that uneven density of each sub pattern is suppressed. It is considered that, for example, when there is the deviation in ejecting characteristics of the nozzles in each head, a tendency of the characteristics do not changed even if the kind of the paper S to be printed is changed. For example, when the ink amount ejecting from a nozzle is small, the dot formed by the nozzle becomes smaller than the dots formed by other nozzles regardless of the kind of the paper S to be printed. Therefore, if the correction value table for correcting the raster line corresponding to the nozzle to be darker is created using any kind of the paper S, there is a high possibility that the correction effect appears even when the printing is performed on another kind of the paper S. As a result, the correction value table created using any kind of the paper S can be applied to the correction of uneven density when the printing is performed on another kind of printing target paper. Therefore, it is possible to reduce the number of the correction value tables to be created.

### Second Embodiment

In the second embodiment, many kinds of correction value tables are created in advance, and a correction table optimized to the printing target paper is selected among the tables. Further, in the second embodiment, the evaluation pattern and the evaluation index which are used in selecting the correction value table are the same as those in the first embodiment.

<Regarding the Selection Sequence of the Correction Value Tables>

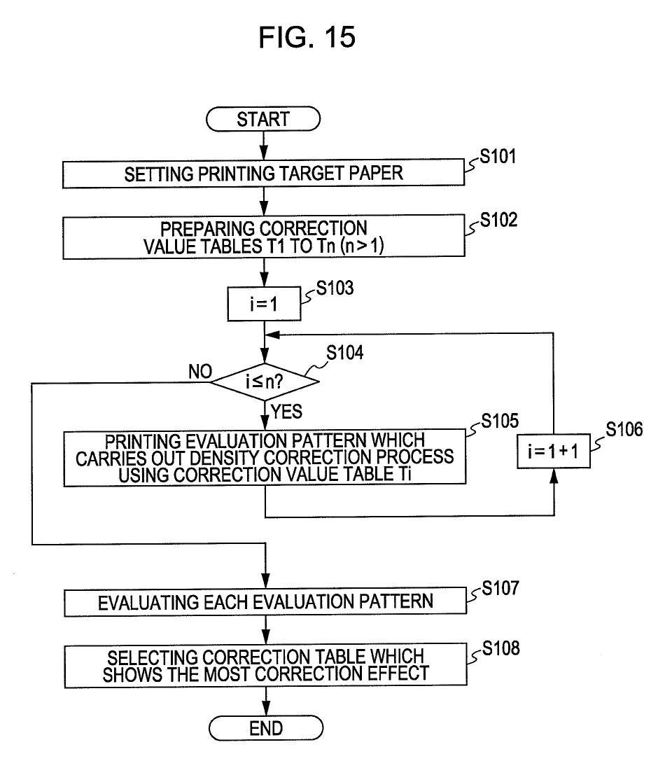

FIG. 15 is a flowchart illustrating selection sequence of the correction value table.

First, the printing target paper is set on the printer 1 (S101).

In the printer 1, the correction value tables T1 to Tn (n>1) created by a composition of n kinds of the paper S, resolution, and dot size is prepared (S102). As the composition thereof, a composition of only the kind of the paper S, a composition of the kind of the paper S and the resolution, or a composition of the kind of the paper S and the dot size may be employed. To sum up, the plural correction value tables created by the composition of one or more out of the kind of the paper S, the resolution, and the dot size may be prepared.

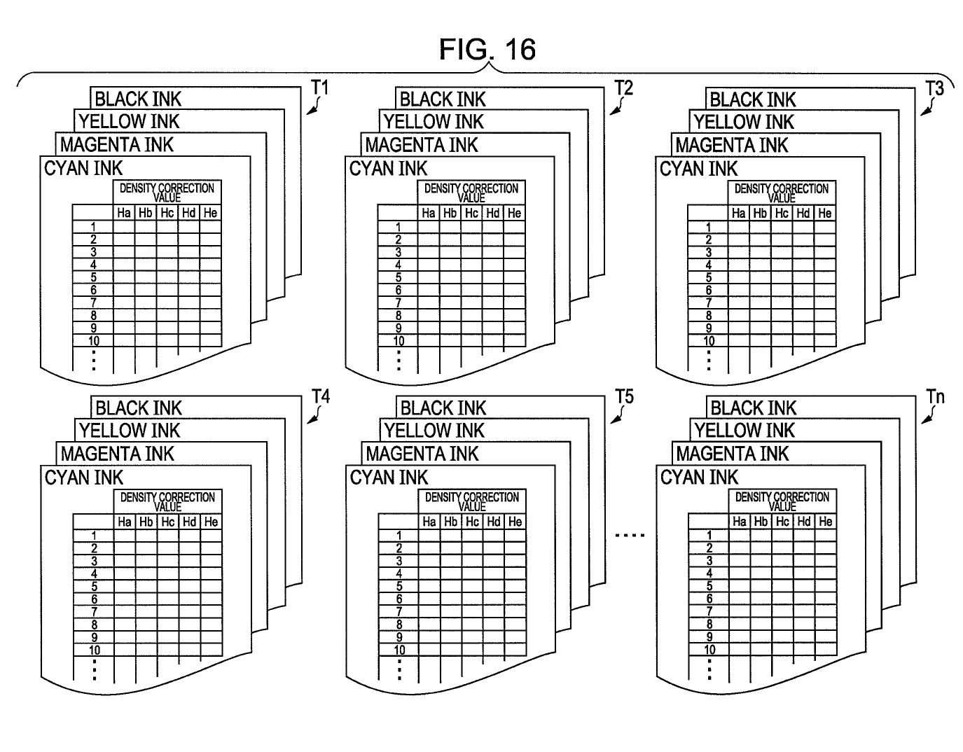

FIG. 16 is a diagram illustrating plural correction value tables. As shown in the drawing, n kinds of the correction value tables T1 to Tn (n>1) are created. A correction value table is created for each color of ink, and the density correction values Ha to He for each of the instructed gradation values Sa to Se are set for each raster line. These correction value tables T1 to Tn are stored in the memory 53 of the printer 1. In this case, in the correction value tables T1 to Tn, a table corresponding to the printing target paper (the correction value table created using the printing target paper) may be prepared.

The computer 110 sequentially selects the correction value tables to be applied. First, i is set to 1 (S103), and then determines whether or not i (=1) is equal to or less than n (S104). Here, since n is larger than 1, the computer 110 determines that i is equal to or less than n (YES in S104), reads the correction value table Ti from the memory 53 of the printer 1, carries out the density correcting process using the correction value table Ti, and prints the evaluation pattern on the printing target paper (S105). For example, when i is equal to 1, the correction value table T1 is applied and the density correcting process is carried out for each raster line, and then the evaluation pattern as illustrated in FIG. 12 is printed on the printing target paper.

Next, the computer 110 adds 1 to i (S106), and performs Step S104 once more in which the determination whether or not i is equal to or less than n is performed. For example, after the correction value table T1 (i=1) is applied, i becomes 2 (=1+1) and then it is determines whether or not 2 is equal to or less than n.

Then, when the computer 110 determines that i is equal to or less than n (YES in S104), Step S105 is performed once more. For example, when i is 2, the evaluation pattern which is subjected to the density correcting process using the correction value table T2 is printed on the printing target paper.

On the other hand, when the computer 110 determines that i is larger than n in Step S104 (NO in S104), the evaluation of the printed evaluation pattern is carried out (S107). Specifically, the respective evaluation patterns printed using the respective correction value tables T1 to Tn are read by the scanner 120, and ΔE94 of the sub pattern in each evaluation pattern described above is obtained from the reading result.

Then, the correction value table corresponding to the pattern in which the maximum correction effect appears is selected as the correction value table to be applied to the printing target paper (S108). In other words, the correction value table in which the value of ΔE94 described above is minimized. When the printing is performed on the printing target medium, the correction is carried out using the selected correction value table.

As described above, the plural kinds of the correction value tables are created in advanced, so that the optimal correction value table (in which uneven density can be reduced to a minimum) can be selected among the plural correction value tables. As a result, since the correction value table may not need to be created for each kind of the paper S, it is possible to reduce the number of the correction value tables. In addition, it is possible to reduce cumbersome tasks or time necessary for the creation of the correction value tables.

### Third Embodiment

### Regarding the Characteristics of Each Band

When the image is formed by each head of the printer 1, a difference in a brightness value of each head occurs due to the difference in the characteristics of the heads. In addition, a tendency of difference in the brightness value of each head is different in each medium. In the second embodiment, when the printing is performed on the printing target paper, the correction value table created by another kind of paper (hereinafter, referred to as a base paper) is used as an offset for each band (region printed by each head).

<Regarding the Creation of the Correction Value Table>

First, the correction value table is created by the correction value acquiring process using the base paper. For example, the correction value acquiring process is carried out on the testing line of the factory manufacturing the printer 1.

As described above, in the correction value acquiring process, the correcting pattern CP (see FIG. 8) is printed on the paper S (which is the base paper in this case) through the nozzles of each head, which is carried out on the basis of the pattern read by the scanner 120.

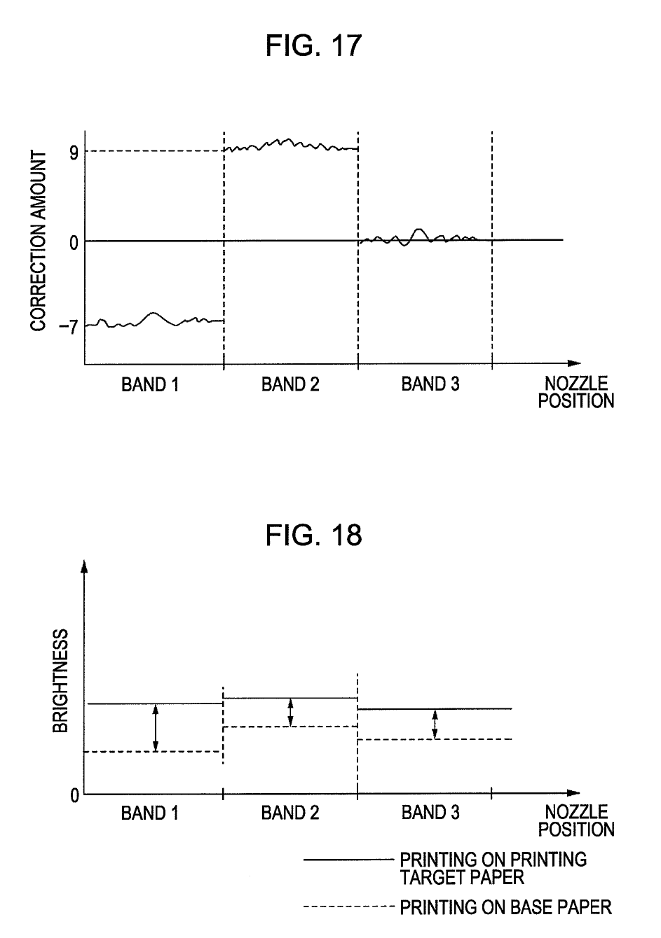

FIG. 17 is a diagram illustrating a relationship between a correction amount of the correction value table for any sub pattern CSP in the correcting pattern CP and a nozzle position (band). The horizontal axis shows the nozzle position (band), and the vertical axis shows the correction amount.

The correction amount for each nozzle is set. In the drawing, it can be seen that the correction amounts for the nozzles are deviated. In addition, it can be seen that the sizes of the correction amounts are different in the respective bands. This is caused by the difference in the characteristics of the heads. For example, in Band 1 (region corresponding to the first head 23A), the correction amount is shown in a minus value, and in Band 2 (region corresponding to the second head 23B), the correction amount is shown in a positive value. That is, when the correction process is not carried out, Band 1 is printed darker than the target density, and Band 2 is printed lighter than the target density. In addition, Band 3 is printed in a density close to the target density.

The correction value table created in the correction value acquiring process is stored in the memory 53 of the printer 1.

<Regarding the Acquisition of the Brightness Value>

Next, when a user performs the printing on the printing target paper of which the kind is different from that of the base paper, the printing target paper is used by the user so as to acquire the brightness value of each band, for example. First, for example, the computer 110 of the user prompts the printer 1 to print the correcting pattern CP on the printing target paper without carrying out the density correcting process. Then, for example, the scanner 120 of the user is prompted to read the correcting pattern CP. Here, the brightness value of each band is acquired for each sub pattern CSP. Further, as described above, the reading resolution for acquiring the brightness value of each band may not be as high as the reading resolution in the correction value acquiring process. That is, an inexpensive scanner can be used as the scanner 120.

FIG. 18 is a diagram illustrating difference in the brightness values of each band of the printing target paper and the base paper. The horizontal axis in the drawing shows the nozzle position, and the vertical axis shows the brightness value. In addition, the dotted line in the drawing shows the brightness value in the case where the printing is performed on the base paper, and the solid line shows the brightness value in the case where the printing is performed on the printing target paper. Further, the printing is performed with the density correcting process is not carried out in both cases. As can be seen from the drawing, the brightness value in each band is different due to difference in the characteristics of the heads.

In addition, when the kinds of the paper are different from each other, the relationship of the brightness value of each band is also different. For example, the difference of the brightness value between the printing target paper and the base paper in Band 1 is large, and the difference of the brightness values becomes smaller in Band 2 and Band 3. In addition, in the drawing, the difference of the maximum value and the minimum value of the brightness value in each band is small in the case where the printing is performed on the printing target paper compared with the case where the printing is performed on the base paper.

As described above, difference occurs in the size of the brightness value of each band according to the kind of the paper used in printing.

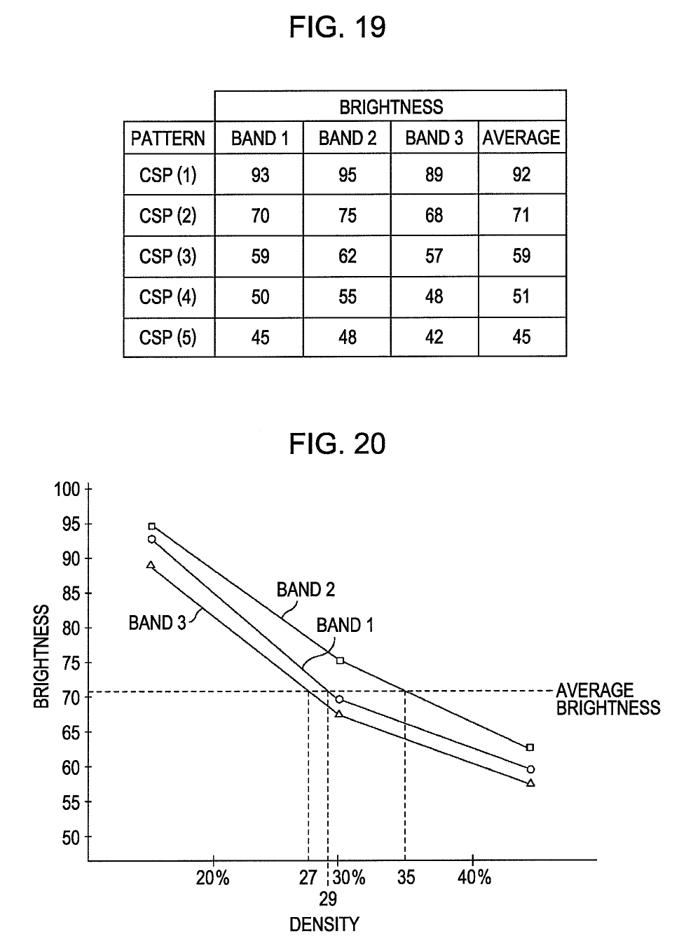

FIG. 19 is a diagram illustrating an example of a relationship between each sub pattern CSP and the brightness value of each band acquired from the printing target paper. Further, as described above, each sub patterns CSP is set such that the density increases along with the order of the number. That is, the brightness value is lowered in order of the number. For example, among the sub patterns, the sub pattern CSP(1) with the density of 15% has the highest brightness value, the sub pattern CSP(5) with density of 85% has the lowest brightness value. In addition, the brightness values are deviated in each band. For example, in the sub pattern CSP(2), the brightness values of each band are 70 in Band 1, 75 in Band 2, and 68 in Band 3. The value 71 {=(70+75+68)/3} obtained by taking an average of the brightness values of each band is an average of the brightness value of the sub pattern CSP(2).

<Regarding the Offset Process>

Next, the offset process will be described. Further, the process is carried out after acquiring the brightness values described above.

FIG. 20 is a diagram illustrating a method of obtaining the correction amount of the offset. Further, the horizontal axis in the drawing shows the density of each sub pattern, and the vertical axis shows the brightness value. In the drawing, the brightness values of the sub pattern CSP(1) with the density of 15%, the sub pattern CSP(2) with the density of 30%, and the sub pattern CSP(3) with the density of 45% are shown. In addition, the circle in the drawing shows the brightness value of Band 1, the rectangular shows the brightness value of Band 2, and the triangle shows the brightness value of Band 3.

As can be seen from the drawing, out of the three bands, Band 2 has the highest brightness (lower density), and Band 3 has the lowest brightness (higher density).

Here, the above-mentioned average brightness value 71 is set as the target brightness value in the sub pattern CSP(2) with the density of 30%, so that the case will be described where an input value (instructed gradation value) of each band is corrected. When the correction amount of each band in correction is set as S, S is obtained as follows.

S=Density having the same brightness value as the average brightness value−Original Density(30%)

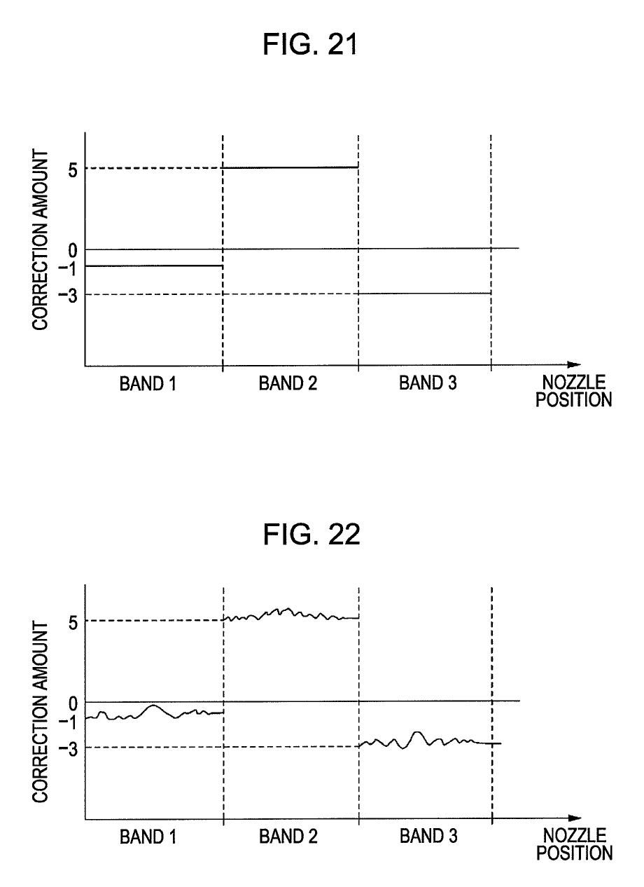

FIG. 21 is a diagram illustrating the correction amount of each band in the sub pattern CSP(2). The horizontal axis in the drawing shows each band (nozzle position), and the vertical axis shows the correction amount.

For example, from the characteristics in FIG. 20, when the density is 29%, the brightness value in Band 1 becomes 71. Therefore, in this case, S becomes −1.

In addition, in Band 2, when the density is 35%, the brightness value becomes 71. Therefore, in this case, S becomes 5.

In addition, in Band 3, when the density is 27%, the brightness value becomes 71. Therefore, in this case, S becomes −3.

FIG. 22 is a diagram illustrating the correction value table after being offset. In FIG. 22, while the relationship of the correction amount of each nozzle in FIG. 17 is maintained, the density correction values H of the correction value table are shifted (offset) in each band, so that the average of the correction amount of each band is equal to that shown in FIG. 21. For example, in Band 1, the correction amount −7 (see FIG. 17) of the average of the density correction value Hb corresponding to the sub pattern CSP(2) is corrected so as to be the correction amount −1. The offset value in this case is 6 (=−1−(−7)). With the offset value, the correction amounts of the density correction values Hb corresponding to the respective nozzles of Band 1 in the correction value table are corrected. In addition, in Band 2, the correction amount 9 of the average of the density correction value Hb is corrected so as to be the correction amount 5. The offset value in this case is −4 (=5−9). With the offset value, the correction amounts of the density correction values Hb corresponding to the respective nozzles of Band 2 in the correction value table are corrected. In addition, in Band 3, the correction amount 0 of the average of the density correction value Hb is corrected so as to be the correction amount −3. The offset value in this case is −3 (=−3−0). With the offset value, the correction amounts of the density correction values Hb corresponding to the respective nozzles of Band 3 in the correction value table are corrected.

The above-mentioned process is similarly carried out also on the other sub patterns CSP or the correcting patterns CP of the other colors. When the printing is performed on the printing target medium, the corrected correction value table is applied, so that the density correcting process is carried out.

When the printing is performed on the printing target paper using the correction value table created by the base paper as described above, the correction value table is corrected in each band so as to carry out the density correcting process. Therefore, it is possible to further reduce uneven density. That is, when the printing is performed on the printing target paper, it is possible to properly use the correction value table created using the base paper.

Further, due to aging deterioration of the printer 1, differences in the characteristics may occur in each head. Even in this case, the correction value table is corrected in each band as described in this embodiment, and the density correcting process is carried out. Therefore, it is possible to reduce uneven density between bands.

### Fourth Embodiment

In the fourth embodiment, the offsets are applied to the plural correction value tables, the evaluation pattern is printed, and an optimal table (an optimal correction value table) is selected among the tables. Further, the following process is carried out when the printing is performed on the printing target paper by a user.

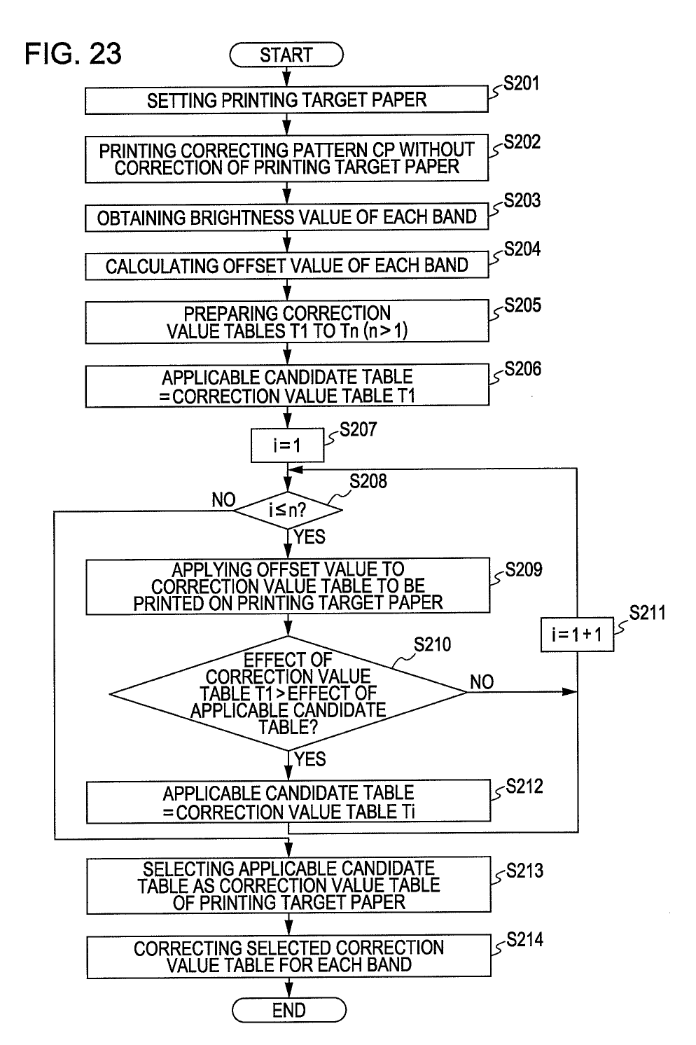

FIG. 23 is a flowchart illustrating a process of the fourth embodiment.

First, the printing target paper is set on the printer 1 (S201). Then, similar to the third embodiment, the computer 110 prompts the printer 1 to print the correcting pattern CP of each color of ink on the printing target paper without carrying out the density correcting process (S202). Then, the scanner 120 is prompted to read the correcting pattern CP, so that the brightness value of each band in each sub pattern CSP is acquired (S203). When the brightness value is acquired, the computer 110 calculates the offset value of each band on the basis of the acquired brightness value (S204).

Next, the evaluation is carried out in which the calculated offset values are applied to the plural correction value tables.

Similar to the second embodiment, in the printer 1, the plural correction value tables T1 to Tn (n>1) are prepared (S205). The computer 110 first sets an applicable candidate table to the correction value table T1 (S206).

Then, the computer 110 sequentially selects the correction tables to be used. First, i is set to 1 (S207), and then determines whether or not i (=1) is equal to or less than n (S208). Here, since n is larger than 1, the computer 110 determines that i is equal to or less than n (YES in S208), reads the correction value table Ti from the memory 53 of the printer 1, carries out the density correcting process in which the offset value is applied to the correction value table Ti, and prints the evaluation pattern on the printing target paper (S209). For example, when i is equal to 1, using the correction value table T1 corrected by the offset value, the evaluation pattern (see FIG. 12) which is obtained by carrying out the density correcting process for each raster line is printed on the printing target paper.

Subsequently, the computer 110 prompts the scanner 120 to read the evaluation pattern, and determines whether or not the correction effect of the correction value table Ti is larger than the correction effect of the applicable candidate table from the read result (S210). Further, when is equal to 1, the correction value table Ti and the applicable candidate table (the correction value table T1) are equal to each other, so that it is determined that the correction value effects are equal (not larger) to each other (NO in S210). Next, the computer 110 adds 1 to i (S211), and performs Step S208 once more in which the determination whether or not i is equal to or less than n is performed. For example, since i is equal to 2 after i=1, it is determined whether or not 2 is equal to or less than n. When it is determined that 2 is equal to or less than n, the computer 110 prints the evaluation pattern on the printing target paper using the correction value table T2 which is corrected by the offset values.

Then, the computer 110 prompts the scanner 120 to read the printed evaluation pattern, and determines whether or not the correction effect of the correction value table Ti is larger than the correction effect of the applicable candidate table from the read result (S210). When i is equal to 2, it is determined whether or not the correction effect of the correction value table T2 is larger than the correction effect of the applicable candidate table (correction value table T1). Further, the determination of the correction effect described above is carried out on the basis of the size of ΔE94 which is obtained from the read result of the scanner 120. When it is determined that the correction effect of the correction value table Ti is less than the correction effect of the applicable candidate table (NO in S210), the computer 110 adds 1 to i (S211) and returns to Step S208.

On the other hand, when the correction effect of the correction value table Ti is larger than the correction effect of the applicable candidate table in Step S210 (YES in S210), the computer 110 changes the applicable candidate table with the correction value table Ti (S212). For example, when i is equal to 2 and it is determined that the correction effect of the correction value table T2 is larger than the correction effect of the applicable candidate table (which is the correction value table T1 in this case), the applicable candidate table is changed from the correction value table T1 to the correction value table T2. Then, the value of i is increased (S211), and the procedure returns to Step S208.

The computer 110 repeatedly carries out the process of S208 to 5212. Then, when it is determined that i is larger than n in Step S208 (YES in S208), the computer 110 selects the correction value table Ti, which is set as the correction table at this time, as the correction value table which is applied to the printing target paper (S213).

When the printing is performed on the printing target paper, the respective density correction values H (Ha to He) of the selected correction value table are corrected in each band with the offset values (S214).

As a result, the correction value table selected among the plural correction value tables can be corrected such that uneven density decreases more. Therefore, it is possible to further reduce uneven density.

### Fifth Embodiment

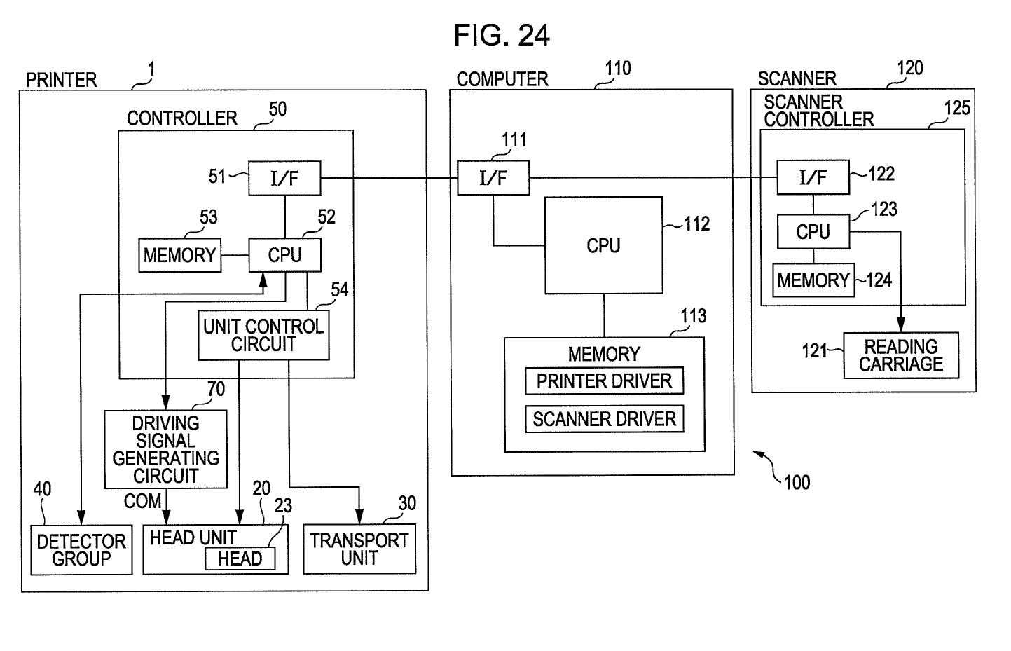

FIG. 24 is a block diagram illustrating a configuration of the printing system 100 of the fifth embodiment. Further, in FIG. 24, the same components as those shown in FIG. 1 are designated by the same reference numerals and the description thereof will be omitted.

The printer 1 of the fifth embodiment includes a driving signal generating circuit 70.

The driving signal generating circuit 70 is a circuit for generating a driving signal COM which is applied to a piezoelectric element (which will be described later) in the head. The driving signal generating circuit 70 carries out analog-digital conversion, voltage amplification, current amplification, and the like on the basis of digital data which is output from the CPU 52 of the controller 50, so that the driving signal COM in an analog waveform is generated and output to the head unit 20.

### <Regarding the Ink Ejecting Mechanism>

Next, the ink ejecting mechanism of the printer 1 will be described.

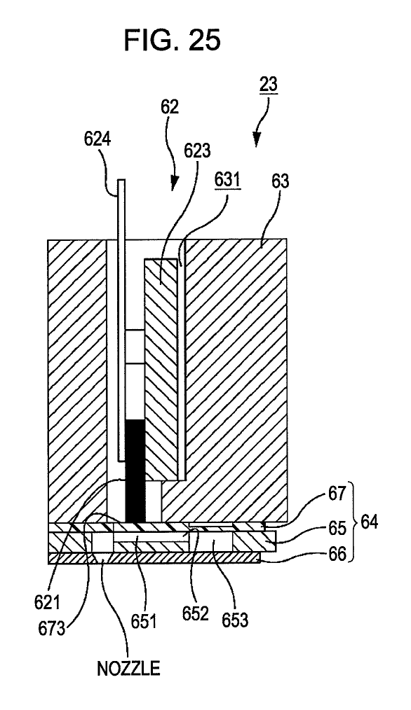

FIG. 25 is a diagram specifically illustrating an example of the ink ejecting mechanism in the head 23. The ink ejecting mechanism is provided with a driving unit 62 and a fluid passage unit 64. The driving unit 62 includes plural piezoelectric elements 621, a fixing plate 623 to which the piezoelectric element group 621 is fixed, and a flexible cable 624 which supplies the electric power to the respective piezoelectric elements 621. Each piezoelectric element 621 is attached to the fixing plate 623 in a cantilever state. The fixing plate 623 is a plate-like member which has rigidity capable for bearing up against reactive force from the piezoelectric element 621. The flexible cable 624 is a sheet-like circuit board with flexibility, and is electrically connected to the piezoelectric element 621 on a fixed end side surface which is an opposite side to the fixing plate 623. Then, on the surface of the flexible cable 624, a head control unit (not shown) is mounted as a controlling IC for controlling driving of the piezoelectric element 621 or the like.

The fluid passage unit 64 includes a fluid passage formation substrate 65, a nozzle plate 66, and an elastic plate 67. The fluid passage formation substrate 65 is interposed between the nozzle plate 66 and the elastic plate 67 so as to be integrally laminated. The nozzle plate 66 is a thin plate made of stainless steel in which the nozzle is formed.

The fluid passage formation substrate 65 is formed such that plural spaces each configured with a pressure chamber 651 and an ink supply port 652 correspond to the respective nozzles. A reservoir 653 is a liquid storing tank for supplying ink stored in an ink cartridge to each pressure chamber 651, and is linked with the other end of the corresponding pressure chamber 651 through the ink supply port 652. Then, the ink from the ink cartridge passes through an ink supply tube (not shown) so as to be introduced into the reservoir 653. The elastic plate 67 is provided with an island portion 673. Then, the tip end of the free end of the piezoelectric element 621 is bonded to the island portion 673.

When the driving signal COM is supplied to the piezoelectric element 621 via the flexible cable 624, the piezoelectric element 621 expands and contracts so as to make the volume of the pressure chamber 651 expand and contract. The volume change of the pressure chamber 651 leads to generate pressure variation in ink stored in the pressure chamber 651. Then, using the pressure variation in ink, the ink can be ejected from the nozzle.

<Regarding the Driving Signal>

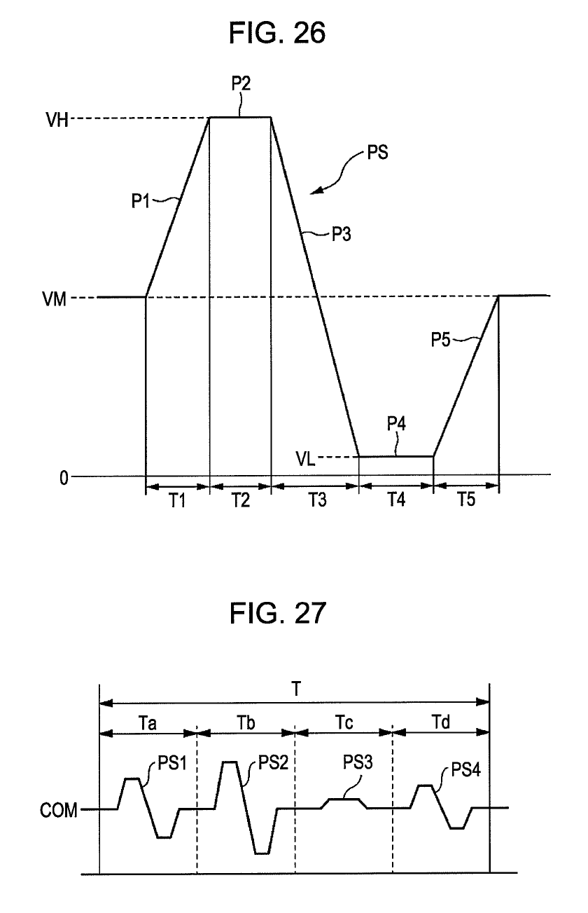

Next, the driving signal will be described which carries out an operation of ejecting ink from the nozzle by driving the piezoelectric element 621. FIG. 26 is a diagram illustrating a part of an example of the driving signal COM.

The driving signal COM includes a driving pulse PS as shown in the drawing. The driving pulse PS includes an expansion part P1 which increases a potential at a predetermined gradient from a medium potential VM to a maximum potential VH, an expansion hold part P2 which holds the maximum potential VH for a predetermined time, an ejection part P3 which decreases a potential at a steep gradient from the maximum potential VH to a minimum potential VL, a contraction hold part P4 which holds the minimum potential VL for a predetermined time, and a damping part P5 which increases a potential from the minimum potential VL to the medium potential VM.

When the driving pulse PS is applied to the piezoelectric element 621, a predetermined amount of ink is ejected from the corresponding nozzle.

That is, while the expansion part P1 is supplied, the piezoelectric element 621 shrinks largely during a period T1. By this, the pressure chamber 651 expands from a normal volume corresponding to the medium potential VM to a maximum volume corresponding to the maximum potential VH. As the expansion goes on, the inside of the pressure chamber 651 is reduced in pressure, and the ink in the reservoir 653 flows into the pressure chamber 651 through the ink supply port 652. The expansion state of the pressure chamber 651 is held during a period T2 for supplying the expansion hold period P2.

Subsequently, when the ejection part P3 is supplied to the piezoelectric element 621, the piezoelectric element 621 expands largely during a period T3. Then, the pressure chamber 651 contracts rapidly to its minimum volume. As the contraction goes on, the ink in the pressure chamber 651 is reduced in pressure, and a predetermined amount of ink is ejected from the nozzle. Subsequently to the discharge part P3, when the contraction hold part P4 is supplied to the piezoelectric element 621, the contraction state of the pressure chamber 651 is held during a period T4. Then, in the contraction state of the pressure chamber 651, a meniscus (surface of ink exposed at the nozzle opening) is affected by the ejection of ink so as to vibrate significantly.

Thereafter, the damping part P5 is supplied at a timing in which the vibration of the meniscus can be suppressed, and the pressure chamber 651 expands and returns to the normal volume during the period T5. That is, in order to cancel the pressure of ink in the pressure chamber 651, the pressure chamber 651 is prompted to expand, so that the ink pressure is reduced. As a result, the vibration of the meniscus can be carried out for a short time, and the next ejection of ink can be stabilized.

The plural driving pulses are continuously generated and constitutes the driving signal COM. Further, as can be seen from the above-mentioned description, the amount of ink ejected from the nozzle depends on the voltage amplitude of the pulse PS of the driving signal COM. For example, as the voltage amplitude increases, the amount of ink ejected from the nozzle becomes larger. As a result, the size of the dot to be formed becomes larger. On the contrary, as the voltage amplitude decreases, the amount of ink ejected from the nozzle becomes smaller. As a result, the size of the dot to be formed becomes smaller.

FIG. 27 is a diagram illustrating the driving signal COM. The driving signal COM is repeatedly generated at each repetitive period T. The driving signal COM includes a first section Ta to a fourth section Td. The first section Ta includes a first driving pulse PS1, and the second section Tb includes a second driving pulse PS2. In addition, the third section Tc includes a third driving pulse PS3, and the fourth section Td includes a fourth driving pulse PS4.

When the first driving pulse PS1 is applied to the piezoelectric element 621, the ink forming a medium dot is ejected onto the paper. Further, the first driving pulse PS1 is a pulse corresponding to a dot gradation value “10” in a halftone process which will be described later.

In addition, when the second driving pulse PS2 is applied to the piezoelectric element 621, the ink forming a large dot is ejected onto the paper. Further, the second driving pulse PS2 is a pulse corresponding to the dot gradation value “11” in the halftone process which will be described later.

In addition, when the third driving pulse PS3 is applied to the piezoelectric element 621, the piezoelectric element 621 minutely vibrates, but the ink is not ejected. Further, the third driving pulse PS3 is a pulse corresponding to the dot gradation value “00” in the halftone process which will be described later.

In addition, when the fourth driving pulse PS4 is applied to the piezoelectric element 621, the ink forming a large dot is ejected onto the paper. Further, the fourth driving pulse PS4 is a pulse corresponding to the dot gradation value “01” in the halftone process which will be described later.

The first driving pulse PS1 to the fourth driving pulse PS4 are selectively applied to each piezoelectric element 621.

<Regarding the Evaluation Pattern>

It is considered that uneven density occurs when the correction value table created by paper different from the printing target paper is applied when the printing is performed on the printing target paper. It is known that when the dot size increases, uneven density is suppressed. However, on the other hand, the granularity which is a visual index of the image becomes larger. Therefore, in the fifth embodiment, the dot size is adjusted on the basis of the relationship between the uneven density and the granularity as described later. Further, in the fifth embodiment, the case where the printing is performed using a single dot size will be described.

First, the evaluation pattern using in this embodiment will be described.

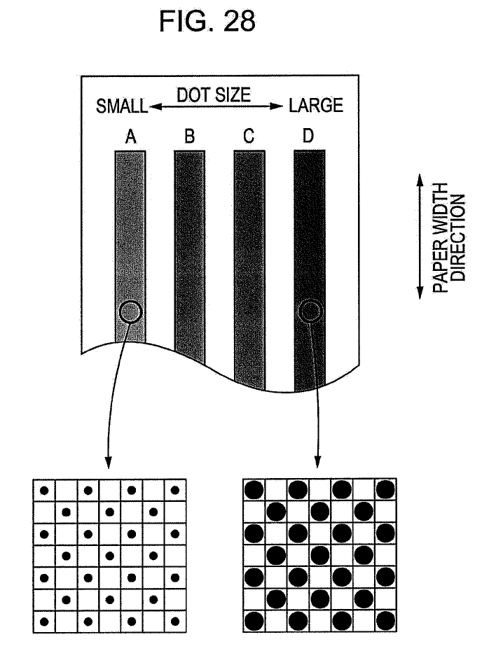

FIG. 28 is a diagram illustrating an example of the evaluation pattern which is used in the fifth embodiment. In the drawing, four patterns of A to D are formed. Each of these patterns is formed using three heads (the first head 23A, the second head 23B, and the third head 23C). Further, each pattern is formed over three regions of Band 1, Band 2, and Band 3 in the paper width direction. In addition, in each pattern, the dots are formed in the same arrangement. For example, in this embodiment, the dots are formed in a checkered pattern as shown in the enlarged drawing.

In addition, when each of these patterns is formed, the controller 60 changes the size of the voltage amplitude (the difference between VH and VL in FIG. 26) of the driving pulse in the driving signal COM for driving the piezoelectric element. Therefore, the respective patterns are formed in a different size. Specifically, when the respective patterns are formed, the controller 60 increases the voltage amplitude of the driving pulse in order of Pattern A, Pattern B, Pattern C, and Pattern D. Therefore, Pattern A is formed with the smallest dot size, and the size increases in order from Pattern B and Pattern C. Then, Pattern D is formed with the maximum dot size. In this way, the voltage amplitude of the driving signal COM is changed, so that the dot size is adjusted. Therefore, the adjustment of the dot size can be accurately and easily carried out.

Such an evaluation pattern is printed on the printing target paper, and the image is read by the scanner 120 for example, so that the density deviation and the granularity to be described later are calculated in each pattern (that is, the dot size). In the following, the density deviation and the granularity which are an evaluation index in this embodiment will be described.

<Regarding Uneven Density>

In this embodiment, as an index indicating the density deviation, the color difference formula ΔE94 is used. ΔE94 is expressed as in the following Equation.

ΔE94=√{(ΔH*/Sh)²+(ΔL*/SL)²+(ΔC*/Sc)²}

Further, L*, C*, and H* are intensity, saturation, and hue of the L*a*b* colorimetric system. Here, SL=1, Sc=1+0.045C*, and Sh=1+0.015C*.

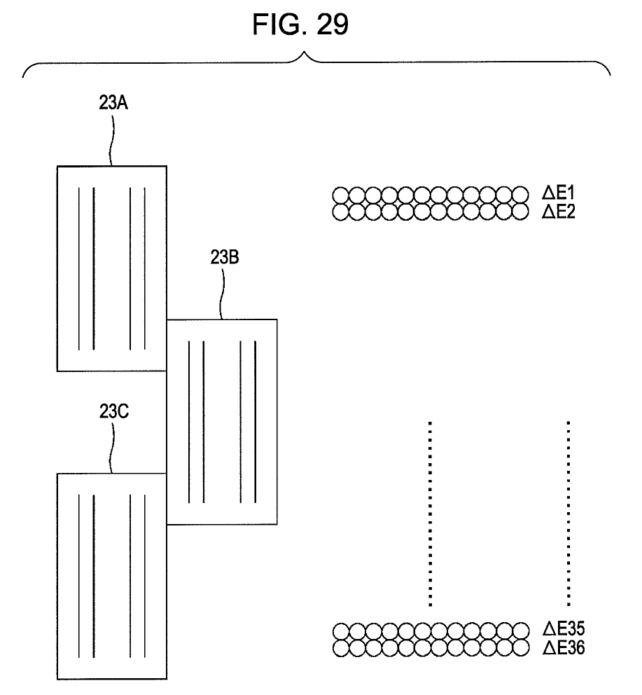

FIG. 29 is a diagram illustrating a concept of the color difference formula ΔE94.

When the printing is carried out on the paper S using the nozzles of each head, the raster lines corresponding to the nozzles are formed in the row region of the paper S as described above. The scanner 120 reads the raster lines, so that the RGB value indicating the density of the pixel row corresponding to each raster line is obtained for each pixel row. In this embodiment, the RGB value is converted into a component (hereinafter, referred to as the Lab values) of the L*a*b* colorimetric system. When the average of all the Lab values of the raster lines is denoted as (L*_{H}, a*_{H}, b*_{H}), and the Lab value of the n-th raster line is denoted as (L*ₙ, a*ₙ, b*ₙ), the color difference between the average of the Lab values and the Lab value of the n-th raster line is expressed by a distance between two points in the L*a*b* space. For example, when the Lab value of the 1st raster line is denoted as (L*₁, a*_{I}, b*₁), the color difference ΔE₁ of the average value (L*_{H}, a*_{H}, b*_{H}) is obtained by the following equation.

ΔE₁=√{(L*_{H}−L*₁)²+(a*_{H}−a*₁)²+(b*_{H}−b*₁)²}

Similarly, the color difference ΔEₙ between the average value (L*_{H}, a*_{H}, b*_{H}) and the Lab value of the n-th raster line is obtained. A value obtained by taking an average of these color difference (ΔE₁ to ΔE₃₆ in this embodiment) corresponds to ΔE94.

Therefore, as can be seen from the above-mentioned relationship, when the density deviation increases (the deviation in the Lab values of the respective raster lines), the value of ΔE94 increases. On the contrary, when the density deviation decreases (the deviation in the Lab values of the respective raster lines), the value of ΔE94 decreases. In this way, by using ΔE94 as the evaluation index, a range of the density deviation to be described later can be accurately determined.

Further, the evaluation index of the density deviation is not limited to the above-mentioned description. For example, it may be configured such that the absolute value (target value) rather than the average value of the respective raster lines is set, and the color difference between the absolute value and each raster line is obtained.

<Regarding the Granularity>

The granularity is a visual index quantitatively indicating a level of the density deviation of the image.

In this embodiment, as a formula for computation of granularity, the following Equation (4) based on the Dooly and Shaw's evaluation formula is used.

Granularity=a(L*)∫(WS(u))^{0.5}VTF(u)du (4)

Here, u is a spatial frequency, WS is a Wiener spectrum of the image, VTF (Visual Transfer Function) is a spatial frequency characteristics of visual sense, and a is a density correction term.

The Wiener spectrum WS is a term obtained such that the image data (RGB) read by scanning the image is converted into the L*a*b* space using 3D-LUT (3-dimensional lookup table), and the L* component is subjected to 2-dimensional Fourier transform (FFT), and then is converted into a polar coordinate system so as to be changed to one dimension.

The spatial frequency characteristics VTF are the characteristics regarding the visual sensitivity of human eyes. In this embodiment, as the VTF, the following Equation (5) is used.

VTF(u)=5.05exp(−0.138πlu/180){1−exp(−0.1πlu/180)} (5)

Further, 1 is a visibility distance and set to 300 mm in this embodiment.

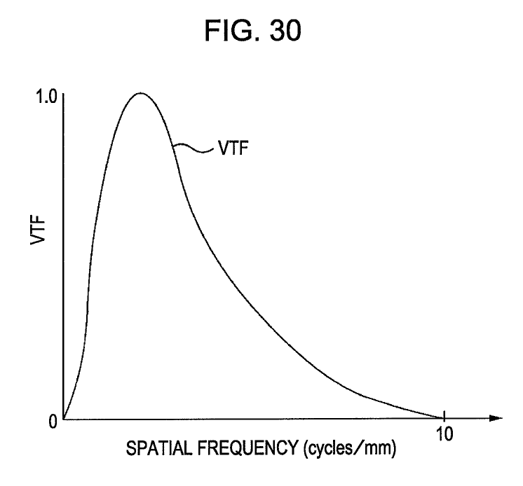

FIG. 30 is a conceptual diagram illustrating the special frequency characteristics VTF. The horizontal axis in the drawing shows the spatial frequency (u), and the vertical axis shows the VTF. The spatial frequency characteristics VTF can be regarded as a filter (what is called a low pass filter) which suppresses high frequency components desensitizing the visual sensitivity of human eyes.

In addition, the density correction term a is a coefficient for matching the value obtained on the basis of the Wiener spectrum WS and the VTF with the sensitivity of the human eyes. In this embodiment, as the density correction term a, the following Equation (6) is used.

a(L*)=((L*+16)/116)^{0.8} (6)

In this way, using the above-mentioned Equation, the granularity is calculated from the data obtained by reading the evaluation pattern. Further, it is preferable that the granularity is small. When the granularity exceeds a predetermined magnitude, it is easy to identify the granularity (noise). Therefore, in this embodiment, the range (hereinafter, referred to as an allowable range) in which a magnitude of the granularity is allowed is provided in advance as described later. In this embodiment, since the granularity is quantitatively calculated by Equation (4), the allowable range can be accurately determined.

<Regarding the Printing Process>

Next, the printing process of this embodiment will be described.

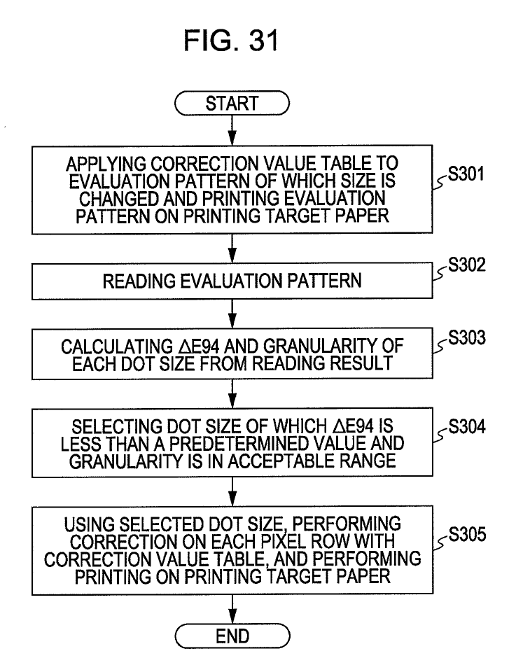

FIG. 31 is a block diagram illustrating the printing process according to the fifth embodiment. Further, FIG. 31 shows a process which is carried out when a user performs the printing on a different kind of the printing target paper from the base paper. The correction table for the base paper is created in a testing line of a factory manufacturing the printer 1, which is not shown in the drawing. Then, the correction value table is stored in the memory 53 of the printer 1.

The printer driver of the user's computer 110 creates the printing data from the image data of the evaluation pattern. Then, the computer 110 prompts the printer 1 to print the respective patterns (Pattern A to Pattern D which are different from each other in the dot size) of the evaluation pattern as shown in FIG. 28 on the basis of the printing data (S301). Further, the printer driver creates the printing data which is obtained by correcting the image data in each raster line (each pixel row) of the evaluation pattern. Therefore, the evaluation pattern printed on the printing target paper can be regarded as the pattern (test pattern) on which the correction value table is applied.

Next, the computer 110 prompts the scanner 120 to read the respective patterns in the printed evaluation pattern (S302). The computer 110 calculates ΔE94 and the granularity described above for each pattern (that is, each dot size) on the basis of the reading result (S303). When ΔE94 and the granularity are calculated, the computer 110 selects the dot size, with which ΔE94 is in a predetermined value and the granularity is in the allowable range, on the basis of the calculation result (S304).

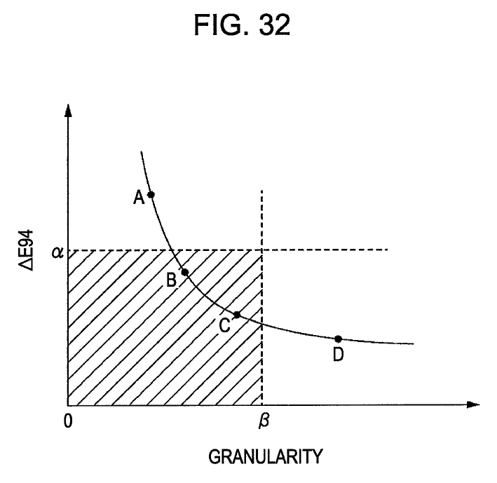

FIG. 32 is a diagram illustrating selection of the dot size. The horizontal axis in the drawing shows the size of the granularity, and the vertical axis shows the size of ΔE94. In addition, a in the drawing is the maximum value of the range of the color unevenness which is determined in advance in this embodiment. That is, in this embodiment, the color unevenness is included in the range from zero to α. In addition, β in the drawing is an allowable value of the granularity. That is, the allowable range of the granularity in this embodiment is in the range from zero to β.

In addition, the respective points A, B, C, and D in the drawing show that the calculation results of ΔE94 and the granularity of Pattern A, Pattern B, Pattern C, and Pattern D are plotted. Further, as described above, the dot sizes are in the relationship of A<B<C<D.

As can be seen from the drawing, when the dot size increases, ΔE94 becomes smaller. For example, comparing A with B in the drawing, B of which the dot size is larger has ΔE94 smaller than that of A.

In addition, as can be seen from the drawing, when the dot size increases, the granularity becomes larger. For example, comparing C with D in the drawing, D of which the dot size is larger has the granularity larger than that of C.

In this way, when the dot size increases, it is possible to decrease the density deviation, but on the other hand, the granularity becomes larger. On the contrary, when the dot size decreases, it is possible to decrease the granularity, but on the other hand, the density deviation becomes larger.

In this embodiment, the pattern (dot size) is selected where ΔE94 is in the range from zero to α and the granularity is in the range from zero to β. That is, the pattern is selected such that the density deviation and the granularity are in the region marked with diagonal lines as shown in FIG. 32. As a result, it is possible to carry out the printing in which both the density deviation and the granularity are satisfied.

In the case of this embodiment, since the points B and C are positioned in the region marked with the diagonal lines in the drawing, the dot size of Pattern B or the dot size of Pattern C is selected. Further, which one is selected may be performed by assigning priority to ΔE94 (the density deviation) and the granularity. For example, when the granularity is given priority, the dot size of Pattern B is selected.

After the dot size is determined in Step S304, when the printing is performed on the printing target paper, the computer 110 uses the dot size and carries out the correction on each raster line applied with the correction value table created by the base paper, and prompts the printer 1 to perform the printing (S305).

In this way, since the dot size with which the density deviation and the granularity are in a predetermined range is selected and used, it is possible that the correction value table created by the base paper is properly applied to the printing target paper to be printed.

Hereinbefore, in this embodiment as described above, when the printing is performed on the printing target paper, the correction value table created by the base paper is used. In addition, at this time, instead of first carrying out the calculation of the density deviation (ΔE94) and the granularity on the evaluation pattern, the dot size with which the density deviation is in a predetermined range and the granularity is in an allowable range is used. In this way, since the density deviation and the granularity are considered, it is possible to properly apply the correction value table created by the base paper to perform the printing on the printing target paper. That is, there is no need to create the correction value table for each medium, and it is possible to achieve a reduction of the number of correction value tables.

### Sixth Embodiment

In the fifth embodiment, the case where the printing is performed using a single dot size has been described. In the sixth embodiment, the case where the printing is performed using the plural dot sizes will be described. In the sixth embodiment, when the printing is performed, three dot sizes (the large dot, the medium dot, and the small dot) are used. Further, the driving signal COM forming dots with each dot size is shown in FIG. 27 as described above. When the entire voltage amplitude of the driving signal COM is changed, the sizes of each dot size of the large dot, the medium dot, and the small dot are uniformly changed.

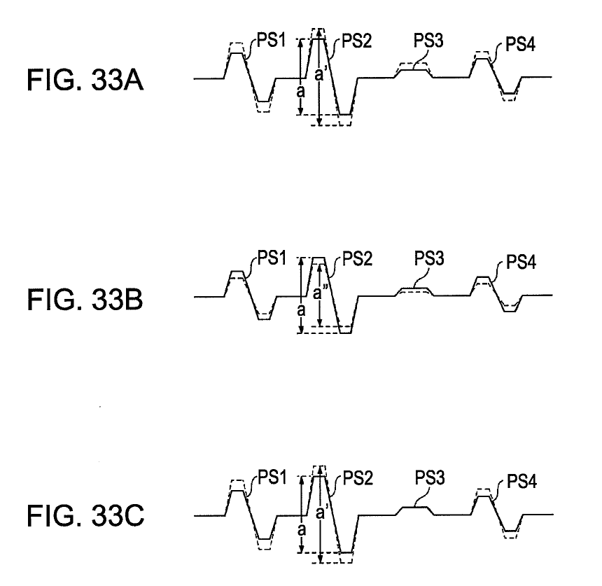

FIGS. 33A, 33B, and 33C are diagram illustrating a case where the voltage amplitude of the driving signal COM is changed. Further, FIG. 33A is a diagram illustrating a case where the voltage amplitude of the driving signal COM increases. FIG. 33B is a diagram illustrating a case where the voltage amplitude of the driving signal COM decreases. FIG. 33C is a modified example of that shown in FIG. 33A. In addition, the solid line in the drawing shows the driving signal COM before the voltage amplitude is changed, and the dotted line in the drawing shows the driving signal COM after the voltage amplitude is changed. In addition, a in the drawing is the entire voltage amplitude (that is, the voltage amplitude of the second driving pulse PS2 having the largest voltage amplitude) of the driving signal COM.

As described above, the first driving pulse PS1 is a pulse for forming the medium dot, the second driving pulse PS2 is a pulse for forming the large dot, the third driving pulse PS3 is a pulse for minutely vibrating (ink is not ejected) the piezoelectric element 621, and the fourth driving pulse PS4 is a pulse for forming the small dot. The size of the voltage amplitudes of the respective pulses are in the relationship of PS3<PS4<PS1<PS2.

Here, as shown in FIG. 33A, when the voltage amplitude a of the second driving pulse PS2 increases (to a'), the waveform of the driving signal COM is changed as the dotted line in FIG. 33A. That is, the voltage amplitudes of the first driving pulse PS1, the third driving pulse PS3, and the fourth driving pulse PS4 also increase in proportion to the change of the second driving pulse PS2. As a result, the respective dot sizes of the large dot, the medium dot, and the small dot increase.

In addition, as shown in FIG. 33B, when the voltage amplitude a of the second driving pulse PS2 decreases (to a″), the waveform of the driving signal COM is changed as the dotted line in FIG. 33B. That is, the voltage amplitudes of the first driving pulse PS1, the third driving pulse PS3, and the fourth driving pulse PS4 also decrease in proportion to the change of the second driving pulse PS2. As a result, the respective dot sizes of the large dot, the medium dot, and the small dot decrease.

As described above, the entire voltage amplitude of the driving signal COM is changed, so that the voltage amplitudes of the respective pulses for forming the large dot, the medium dot, and the small dot are uniformly changed. Therefore, the sizes of the large dot, the medium dot, and the small dot are changed.

Further, as shown in FIG. 33A, when the voltage amplitude of the driving signal COM increases and also the third driving pulse PS3 for minutely vibrating the piezoelectric element 621 increases, there is some concerns that ink may be mistakenly ejected by the third driving pulse PS3. As shown in FIG. 33C, only the third driving pulse PS3 may not be changed. As a result, it is possible to surely prevent ink from being ejected when the piezoelectric element 621 minutely vibrates.

In the sixth embodiment, as the evaluation pattern, five patterns which are obtained by changing the voltage amplitude of the driving signal COM are printed. Specifically, the computer 100 prints patterns, which are changed in size of the voltage amplitude of the driving signal COM to be 0.8 times, 0.9 times, 1.0 times (reference), 1.1 times, and 1.2 times, on the printing target paper by the printer 1. In addition, in the sixth embodiment, when the respective patterns of the evaluation pattern are printed, three dot sizes of the large dot, the medium dot, and the small dot are used.

Further, in each pattern, mixture fractions of the large dot, the medium dot, and the small dot are equal to each other, but the respective dot sizes of the large dot, the medium dot, and the small dot are different from each other in each pattern. As described above, in the fifth embodiment, the respective patterns in the evaluation pattern are formed in a single dot size, but in the sixth embodiment, the respective patterns are formed such that three dot sizes of the large dot, the medium dot, and the small dot are mixed in a predetermined fraction.

Then, the computer 110 prompts the scanner 120 to read the printed evaluation pattern, and calculates the density deviation and the granularity of each pattern from the read result as in the fifth embodiment. Then, the computer 110 selects an optimal pattern from the result.

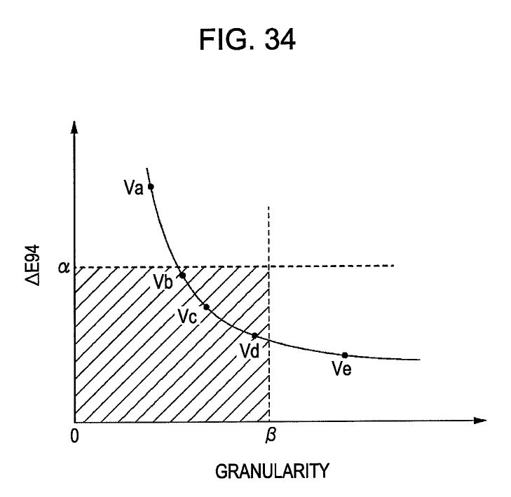

FIG. 34 is a diagram illustrating selection of the dot size of according to the sixth embodiment. Further, the respective points of Va, Vb, Vc, Vd, and Ve in the drawing show that the calculation results of the respective patterns are plotted when the voltage amplitude of the driving signal COM is set to 0.8 times, 0.9 times, 1.0 times, 1.1 times, and 1.2 times.

Further, also in the sixth embodiment, similar to the fifth embodiment, the range (which corresponds to the portion marked with the diagonal lines as shown in FIG. 34) is determined in which the density deviation is in the range from zero to α and the granularity is in the range from zero to β. That is, the density deviation and the granularity are determined so as to be the values in the portion marked with the diagonal lines as shown in FIG. 34. In the sixth embodiment, the pattern in which the calculation result of the density deviation and the granularity is in the range is determined. In other words, the respective dot sizes of the large dot, the medium dot, and the small dot which are used to form the pattern in the range marked with the diagonal lines are selected.

In the drawing, when the voltage amplitude increases (in order of Va, Vb, Vc, Vd, and Ve), the density deviation decreases, but on the other hand, it can be seen that the granularity increases. This is because the dot sizes (the large dot, the medium dot, and the small dot) according to the voltage amplitude increase uniformly.

On the contrary, when the voltage amplitude decreases (in order of Ve, Vd, Vc, Vb, and Va), the granularity decreases, but on the other hand, it can be seen that the density deviation increases. This is because the dot sizes (the large dot, the medium dot, and the small dot) according to the voltage amplitude decrease uniformly.

In FIG. 34, among five patterns, there are three patterns of Vb, Vc, and Vd which are in the region marked with the diagonal lines. Therefore, these three patterns become selection candidates, and the computer 110 selects any one of these three patterns. Further, which pattern is selected may be carried out by the selection priority which is determined in advance. For example, when the granularity is given priority, Vb may be selected. When the density deviation (ΔE94) is given priority, Vd may be selected. In addition, when the granularity and the density deviation are given the same priority, Vc may be selected.

Then, when the printing is performed on the printing target paper, the computer 110 prompts the printer 1 to print by using the large dot, the medium dot, and the small dot which correspond to the voltage amplitude of the selected pattern, and by applying the correction value table created by the base paper so as to carry out the correction on each raster line.

In the sixth embodiment, the printing is carried out using the large dot, the medium dot, and the small dot, and the uneven density and the granularity are in a predetermined range. As a result, even when plural dot sizes are used, it is possible to carry out the printing in consideration of the density deviation and the granularity. In addition, it is possible to properly apply the correction value table created by the base paper to the printing target paper. Therefore, it is possible to reduce the number of the correction value tables.

Further, in the sixth embodiment, three dot sizes are used, but the invention is not limited thereto. For example, two dot sizes may be used, or four or more dot sizes may be used.

### Seventh Embodiment

In the above-mentioned embodiment, as shown in FIG. 28, the dots are formed in the same arrangement in each pattern of the evaluation pattern. That is, the number of dots formed in each pattern is the same. However, in the seventh embodiment, the number of dots (dot density) in each pattern of the evaluation pattern is changed. Further, each pattern of one evaluation pattern is formed in the same dot size. In the seventh embodiment, while the dot size is changed, the plural evaluation patterns (two pieces in this embodiment) are printed.

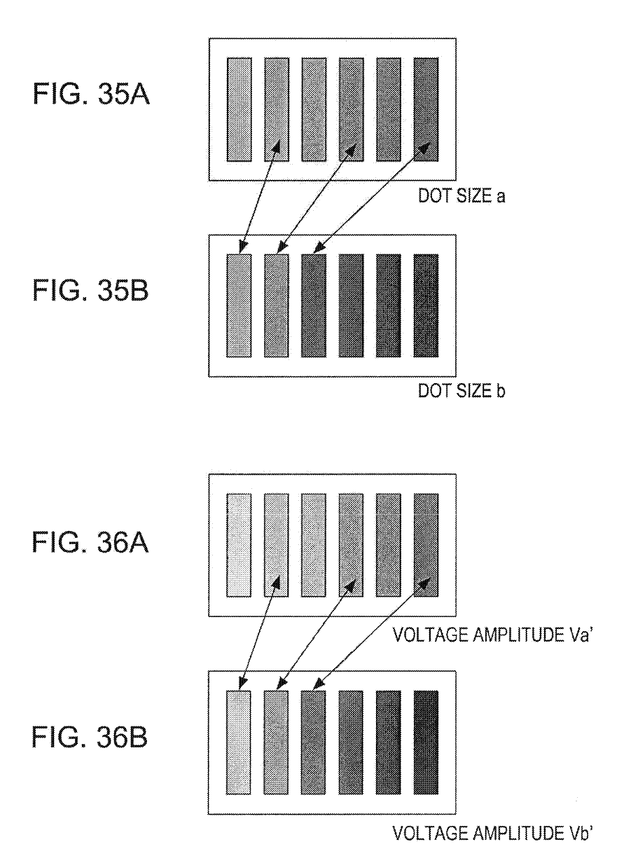

FIGS. 35A and 35B are an example of the evaluation pattern according to the seventh embodiment. In the evaluation pattern shown in FIGS. 35A and 35B, plural patterns of which the gradation values are different from each other are printed while the number of dots is changed. For example, as the pattern is printed on the left side in the drawing, the gradation value becomes higher (the number of dots becomes small), and as the pattern is printed on the right side in the drawing, the gradation value becomes lower (the number of dots becomes larger).

Further, in FIGS. 35A and 35B, the dot sizes used in printing are different. FIG. 35A shows the pattern with a single dot size a, and FIG. 35B shows the pattern with a single dot size b (b>a). Therefore, the entire color shown in FIG. 35B becomes darker (the gradation value is lower) than that shown in FIG. 35A.

Similar to the embodiment described above, the computer 110 prompts the printer 1 to print the evaluation pattern shown in FIGS. 35A and 35B, and prompts the scanner 120 to read the printed evaluation pattern. The computer 110 converts the RGB value of the read result of the scanner 120 into the component (Lab value) of the L*a*b* colorimetric system, so that the L* values the respective patterns are calculated. Then, the computer 110 selects patterns which have almost the same L* value among the respective patterns in FIGS. 35A and 35B. In this embodiment, the respective patterns connected with an arrow in FIGS. 35A and 35B have almost the same value, and thus the computer 110 selects these patterns.

Similar to the embodiment described above, the computer 110 calculates the granularity and ΔE94 of the selected theses patterns. Then, the computer 110 obtains average values of the granularity and ΔE94 for each evaluation pattern, and selects the dot size of which the obtained ΔE94 is in the range from zero to α and the granularity is in the range from zero to β. For example, when ΔE94 selected in FIG. 35A is in the range from zero to α and the granularity thereof is in the range from zero to β, the dot size a is selected. Then, when the printing is performed on the printing target paper, the selected dot size is used.

Also in the seventh embodiment, similar to the fifth embodiment, since the dot size can be selected in consideration of the density deviation and the granularity, it is possible to properly apply the correction value table created by the base paper to the printing target paper.

### Eighth Embodiment

In the seventh embodiment, the single dot size is used in each evaluation pattern, but in the eighth embodiment, plural dot sizes are used in each evaluation pattern.

FIGS. 36A and 36B are an example of the evaluation pattern according to the eighth embodiment. The eighth embodiment is different from the seventh embodiment in that plural dot sizes (the large dot, the medium dot, and the small dot) are used in forming each pattern in each evaluation pattern. Further, the ratio of the large dot, the medium dot, and the small dot is equal to each other in each pattern in the evaluation pattern shown in FIGS. 36A and 36B, but the sizes are different from each other.

For example, in this embodiment, the voltage amplitude of the driving signal COM, when the evaluation pattern shown in FIG. 36A is printed, is Va′, and the voltage amplitude of the driving signal COM, when the evaluation pattern shown in FIG. 36B is printed, is Vb′ (Vb′>Va′). Therefore, in FIG. 368, the dot size is larger than that in the case of FIG. 36A in addition to the large dot, the medium dot, and the small dot. As a result, in FIG. 36B, the color is identified as darker (the gradation value becomes lower) than that in FIG. 36A as a whole.

Also in the eighth embodiment, the computer 110 prompts the printer 1 to print the evaluation pattern shown in FIGS. 36A and 36B, and prompts the scanner 120 to read the printed evaluation pattern. The computer 110 converts the RGB value of the read result of the scanner 120 into the component (Lab value) of the L*a*b* colorimetric system, so that the L* values the respective patterns are calculated. Then, the computer 110 selects patterns which have almost the same L* value among the respective patterns in FIGS. 36A and 36B. In this embodiment, L* values of the patterns connected with an arrow in FIGS. 36A and 36B are almost equal to each other, and thus the computer 110 selects these patterns.

The computer 110 calculates the granularity and ΔE94 of the selected patterns. Then, the computer 110 obtains average values of the granularity and ΔE94 for each evaluation pattern, and selects the dot size of which the obtained ΔE94 is in the range from zero to α and the granularity is in the range from zero to β. For example, when ΔE94 selected in FIG. 36A is in the range from zero to α and the granularity thereof is in the range from zero to β, the dot size a is selected. Then, when the printing is performed on the printing target paper, the selected dot size (the large dot, the medium dot, and the small dot) according to the selected voltage amplitude Va′ is used.

In the eighth embodiment, similar to the sixth embodiment, when the plural dot sizes are used, the printing can be carried out in consideration of the density deviation and the granularity. In addition, it is possible that the correction value table created by the base paper is properly applied to the printing target paper to be printed.

### Other Embodiments

Hereinbefore, the correction value calculating apparatus according to the invention has been mainly described on the basis of the above-mentioned embodiments. However, in the above description, there are also disclosed the color information selecting system for performing the selection of the color information, and the program for causing the computer 110 to perform the color selection process in the color information selecting system. In addition, the embodiments according to the invention described above are to enable easy understanding of the invention, but the invention is not limited thereto. It is matter of course that various changes and improvements can be made in the invention without departing from the main points of the invention, and equivalences are includes in the invention.

<Regarding the Printer 1>

In the above-mentioned embodiments, the line head printer has been described as an example in which the nozzles are arranged in the paper width direction intersecting the transport direction of the medium, but the invention is not limited thereto. For example, the printer may be employed which alternatively performs a dot formation operation for forming the dot row along the moving direction and a transport operation (moving operation) for transporting the paper in the transport direction which is the nozzle row direction, while the head unit moves along the moving direction intersecting a nozzle row direction.

In addition, in the above-mentioned embodiments, the ink jet printer ejecting ink has been described as an example, but the invention is not limited thereto. A liquid ejecting apparatus may be applied which ejects liquid other than ink. For example, there may employ a textile printing apparatus which patterns a cloth, a display manufacturing apparatus such as a color filter manufacturing apparatus or an organic EL display, a DNA chip manufacturing apparatus which manufactures DNA chips by coating the chips with liquid in which DNA is melted, and a circuit board manufacturing apparatus. In addition, as an ink ejecting system for ejecting ink from the nozzles included in the printer 1, a piezo system may be employed which makes the volume of the pressure chamber expand and contract by a piezoelectric element. In addition, a thermal system may be employed which generates bubbles in the nozzle using a thermal element so as to ejects ink by using the bubbles.

<Regarding the Scanner 120>

In the above-mentioned embodiments, there is used the scanner 120 which includes the respective sensors (for example, CCD) of R, G, and B, and reads the reflected light of the light irradiated onto the document by the respective sensors so as to obtain the information of each color of R, G, and B. However, the invention is not limited thereto. For example, there may be used a light source switching system in which fluorescent lamps of each color of R, G, and B are turned on and off and the reflective light is read by a monochrome image sensor so as to acquire the color information of each color of R, G, and B, or a filter switching system in which color filters of R, G, and B are provided between the light source and the sensors so as to acquire the color information of R, G, and B by switching these color filters.

In addition, when the offset value for each band is obtained, the reading of the correcting pattern CP may be carried out using a colorimeter without the scanner. Further, in the case of the colorimeter, the reading of the image is carried out, so that the L* value is obtained. In this case, as in the case of the brightness value, the offset value can be obtained for each band.

<Regarding the Head>

In the above-mentioned embodiments, the ink is ejected using the piezoelectric element. However, the method of ejecting the liquid is not limited thereto. For example, other methods may be used such as a method of generating bubbles in the nozzle by heat.

<Regarding the Adjustment of the Dot Size>

In the above-mentioned embodiments, the voltage amplitude of the driving signal COM is changed, so that the dot size is changed. However, the method of changing the dot size is not limited thereto. For example, the waveform (for example, the slope of the expansion part P1 shown in FIG. 26) of the driving pulse PS of the driving signal COM is changed, so that the dot size may be changed.

1. A printing method comprising:
printing a test pattern, in which a plurality of pixel rows including a plurality of pixels arranged in a predetermined direction are arranged in a direction intersecting the predetermined direction, on a kind of medium;
reading the test pattern printed on the kind of medium by using a reading unit;
obtaining a density correction value for each pixel row on the basis of the read result of the test pattern, and creating a correction value table in which each pixel row is associated with each correction value;
performing correction on each pixel row using the correction value table when the printing is performed on the kind of medium; and
performing correction on each pixel row using the correction value table for the kind of medium when the printing is performed on another kind of printing target medium.

2. The printing method according to claim 1, further comprising:
printing a test pattern, to which the correction value table for the kind of medium is applied, on the printing target medium by changing dot size; and
reading the test pattern to which the correction value table is applied by using the reading unit, and selecting a dot size such that density deviation is in a predetermined range and granularity is in an allowable range on the basis of the read result,
wherein when the printing is performed on the printing target medium, the selected dot size is used.

3. The printing method according to claim 2,
wherein the dot size is changed by changing a voltage amplitude of a driving signal for driving an element which ejects liquid.

4. The printing method according to claim 2,
wherein when the test pattern, to which the correction value table is applied, is printed on the printing target medium,
a plurality of dot sizes are mixed in each pattern at a predetermined ratio, the respective dot sizes are changed in each pattern, and
a plurality of the dot sizes, of which the density deviation is in the predetermined range and the granularity is in the allowable range, and which are used for forming the pattern, are selected on the basis of the read result of the test pattern to which the correction value table is applied.

5. The printing method according to claim 2,
wherein a difference between an average value obtained by reading the pixel rows of the test pattern and a value obtained by reading each pixel row is obtained for each pixel row, and the density deviation is calculated on the basis of an average of the differences obtained for the respective pixel rows.

6. The printing method according to claim 2,
wherein the granularity is calculated on the basis of calculation of a Wiener spectrum calculated on the basis of Fourier conversion implemented on the read result of the test pattern and spatial frequency characteristics which are visual characteristics.

7. The printing method according to claim 1, further comprising:
creating the correction value table for each of a plurality of mediums;
printing a test pattern, to which each of the plurality of the correction value tables is applied, on the printing target medium; and
determining an optimal pattern among the test patterns which are printed on the printing target medium,
wherein when the printing is performed on the printing target medium, the correction is carried out using the correction value table corresponding to the optimal pattern.

8. The printing method according to claim 7, further comprising:
reading the test pattern, which is printed on the printing target medium, by the reading unit; and
calculating, for each pixel row, a difference between an average value obtained by reading pixel rows of the test pattern and a value obtained by reading each pixel row,
wherein the optimal pattern is determined on the basis of an average value of the differences obtained for the respective pixel rows.

9. The printing method according to claim 7, further comprising:
printing the test pattern without carrying out correction on the printing target medium;
reading the test pattern printed on the printing target medium by the reading unit; and
calculating an offset value of each predetermined region, which is configured by a plurality of the pixel rows, on the basis of the read result,
wherein when the printing is performed on the printing target medium, the correction value table for the kind of medium is adjusted by the offset value for each predetermined region so as to perform the correction.

10. The printing method according to claim 1, further comprising:
creating the correction value table for each of a plurality of mediums;
printing the test pattern without carrying out correction on the printing target medium;
reading the test pattern printed on the printing target medium by the reading unit;
calculating an offset value of each predetermined region, which is configured by a plurality of the pixel rows, on the basis of the read result;
adjusting each correction value table by the offset value so as to print a test pattern on the printing target medium; and
determining an optimal pattern among the test patterns which are printed on the printing target medium,
wherein when the printing is performed on the printing target medium, the correction value table corresponding to the optimal pattern is adjusted by the offset value so as to perform the correction.

11. A printing apparatus comprising:
a printing unit which performs printing on a medium by changing dot size;
a reading unit which reads the printed medium; and
a control unit which prompts a test pattern, in which a plurality of pixel rows including a plurality of pixels arranged in a predetermined direction are arranged in a direction intersecting the predetermined direction, to be printed on a kind of medium; obtains a density correction value for each pixel row on the basis of the read result of the test pattern and creates a correction value table in which each pixel row is associated with each correction value; prompts a test pattern, to which the correction value table for the kind of medium is applied, to be printed on another kind of printing target medium different from the kind of the printing target medium by changing dot size; prompts a dot size, in which a density deviation is in a predetermined range and granularity is in an allowable range, to be selected on the basis of the read result of the reading unit reading which is obtained the test pattern printed on the printing target medium; and prompts each pixel row to be corrected by the correction value table using the selected dot size when the printing is performed on the printing target medium.
